(19) United States
(12) Patent Application Publication
(10) Pub. No.: US 2002/0136214 A1
(43) Pub. Date: Sep. 26, 2002

(54) Pervasive computing network architecture

(75) Inventors: Cuong D. Do, Anaheim Hills, CA (US); David Nguyen, Buena Park, CA (US); Lan Nguyen, San Diego, CA (US); Nhut T. Ha, Los Angeles, CA (US); Tudo D. Do, Reseda, CA (US)

Correspondence Address: Kenton R. Mullins, Stout, Uxa, Buyan & Mullins, LLP, Suite 300, 4 Venture, Irvine, CA, 92618, US

(73) Assignee: Consumer Direct Link, Irvine, CA

(21) Appl. No.: 09/930,886

(22) Filed: Aug. 14, 2001

Related U.S. Application Data
(60) Provisional application No. 60/225,185, filed on Aug. 14, 2000.
(60) Provisional application No. 60/226,252, filed on Aug. 17, 2000.

(51) Int. Cl. H04L 12/28; H04L 12/56

(52) U.S. Cl. 370/392; 370/401; 370/338

(57) ABSTRACT

A pervasive computing network is disclosed including a group of first access controllers connected together on a first local area network, with each of the first access controllers including a radio frequency transceiver constructed to transmit and receive radio frequency signals within a range less than about 100 meters and wherein at least two of the ranges of the first access controllers overlap one another and the first access controllers are constructed to communicate with a consumer touchpoint device. The pervasive computing network further includes a group of second access controllers connected together on a second local area network, each of the second access controllers including a radio frequency transceiver constructed to transmit and receive radio frequency signals within a range less than about 100 meters, with at least two of the ranges of the second access controllers overlapping one another and the second access controllers being constructed to communicate with the consumer touchpoint device. The pervasive computing device is further provided with both a first communication line connecting the first group of access controllers to a wide area network; a second communication line connecting the second group of access controllers to the wide area network; and a knowledge center connected to the wide area network in communication with the group of first access controllers and the group of second access controllers, the knowledge center being configured to communicate with the consumer touchpoint device by pushing unrequested data to the consumer touchpoint device when the consumer touchpoint device is within one of the ranges of the group of first access controllers and the group of second access controllers.

### PRIORITY INFORMATION

This application claims the benefit U.S. Provisional Application No. 60/225,185, filed Aug. 14, 2000 and entitled Pervasive Computing Network Architecture; and U.S. Provisional Application No. 60/226,252, filed Aug. 17, 2000 and entitled Credit-Card Sized PC Card and Communication Device.

### BACKGROUND OF THE INVENTION

1. Field of the Invention

The present invention relates to methods and apparatus for communicating electronically, and, more particularly, relates to consumer touchpoint devices for performing electronic functions and transactions.

2. Description of Related Art

Portable electronic communication systems have existed in the prior art. A portable electronic communication system typically permits a user to conduct certain electronic transactions away from a desktop computer, which substantially improves efficiency and convenience to the user. The broad term “electronic transactions” can include transactions conducted via computer networks, automated teller machines (ATM's), automated point-of-sale systems, and the like. Transactions conducted via computer networks may encompass a wide range of transactions, including exchanging information and data via a computer network popularly known as the Internet, e.g., to make a purchase from a vendor on the network. ATM's typically permit users to conduct financial transactions (such as withdrawals, transfers, deposits, and the like) vis-à-vis a financial institution in an electronic manner. Merchants may employ automated point-of-sale systems, for example, to permit users to purchase products or services using the users' electronic account. The above and perhaps other examples of portable electronic communication systems can be found in popular literature.

Electronic transaction systems typically request the user to provide identification data to authenticate herself as the user authorized to approve the proposed transaction or transactions. The identification data may be required with each transaction, or the identification data may be entered by the user at the start of a session to authenticate herself and enable that user to subsequently perform any number of transactions without further authentication or identification. In the prior art, users are typically required to manually enter the identification data into the electronic transaction system for authentication. Typically, the entry of identification data involves typing in a password on a numeric keypad or on a keyboard. The identification data is then compared with data previously stored within the electronic transaction system, and authentication is satisfied when there is a match.

When the electronic transaction system comprises an automated teller machine (ATM), a user will typically insert a data card, such as a bank card or a credit card, into a card reader. The data card often includes a magnetic stripe that contains the account number and other information related to the user, which may then be read by card reader. The data stored in the data card enables the electronic transaction system to ascertain the account with which the user wishes to transact business. Via a keypad on the ATM, the user can then enter her identification data, e.g., her personal identification number (PIN), to authenticate herself. If the entered identification data matches the identification data stored in connection with the electronic transaction system, the user is authenticated and granted access to her account. If there is no match, authentication fails. After authentication, the user may be able to, for example, employ a combination of the keypad and a screen to withdraw cash from her account, which results in cash being dispensed from the ATM and the balance in her account within database being reduced.

Since the identification data is not encrypted before being entered into the ATM, the identification data is vulnerable to unauthorized access and procurement. Encryption of the identification data has not been practical in the mentioned prior-art devices due to the complexity and/or inconvenience to the user of performing encryption or memorizing the encrypted identification data.

There are desired apparatus and methods for conducting electronic transactions with portable electronic communication systems that will enhance convenience and substantially attenuate risks of unauthorized access to users' accounts and identification data. Preferably, such an apparatus should be portable and capable of maintaining geographic and other unique user information to permit the user to conveniently and comfortably perform electronic transaction authentications in a variety of environments.

### SUMMARY OF THE INVENTION

Portable electronic communication devices and methods of using such devices have been discovered. The portable electronic communication devices are capable of maintaining geographic and other unique user information, and of permitting the user to conveniently and comfortably perform electronic transactions in a variety of environments, thus enhancing user convenience, productivity, security and safety.

In accordance with one aspect of the present invention, a pervasive computing network is disclosed including a group of first access controllers connected together on a first local area network, with each of the first access controllers including a radio frequency transceiver constructed to transmit and receive radio frequency signals within a range less than about 100 meters and wherein at least two of the ranges of the first access controllers overlap one another and the first access controllers are constructed to communicate with a consumer touchpoint device. The pervasive computing network further includes a group of second access controllers connected together on a second local area network, each of the second access controllers including a radio frequency transceiver constructed to transmit and receive radio frequency signals within a range less than about 100 meters, with at least two of the ranges of the second access controllers overlapping one another and the second access controllers being constructed to communicate with the consumer touchpoint device.

The pervasive computing device is further provided with both a first communication line connecting the first group of access controllers to a wide area network; a second communication line connecting the second group of access controllers to the wide area network; and a knowledge center connected to the wide area network in communication with the group of first access controllers and the group of second access controllers, the knowledge center being configured to communicate with the consumer touchpoint device by pushing unrequested data to the consumer touchpoint device when the consumer touchpoint device is within one of the ranges of the group of first access controllers and the group of second access controllers.

These and other advantages of the present invention will become apparent upon reading the following detailed descriptions and studying the various figures of the drawings.

### BRIEF DESCRIPTION OF THE DRAWINGS

FIG. 1a is a schematic diagram illustrating a consumer touchpoint device geographically disposed about a plurality of consumer touchpoints, in accordance with a presently preferred embodiment of the present invention;

FIG. 1b is a schematic diagram illustrating other consumer touchpoint devices, also displayed in a field of consumer touchpoints, in accordance with other preferred embodiments of the present invention;

FIG. 2 is a generalized block diagram of the functional components which comprise the consumer touchpoint device in accordance with a preferred embodiment of the present invention;

FIGS. 3a and 3b are generalized block diagrams illustrating the consumer touchpoint device in accordance with a presently preferred embodiment;

FIG. 4 is a generalized block diagram of a modem access controller and the corresponding connections with interactive devices in accordance with an embodiment of the present invention;

FIG. 5 is a schematic representation illustrating a plurality of access zones defined by a corresponding plurality of access controllers in accordance with the presently preferred embodiment;

FIG. 6 is another schematic diagram illustrating a knowledge center in accordance with a presently preferred embodiment;

FIG. 7 is yet another schematic diagram showing further features of the knowledge center in accordance with the presently preferred embodiment; and

Additional drawings are attached and discussed below.

### DETAILED DESCRIPTION OF THE PRESENTLY PREFERRED EMBODIMENTS

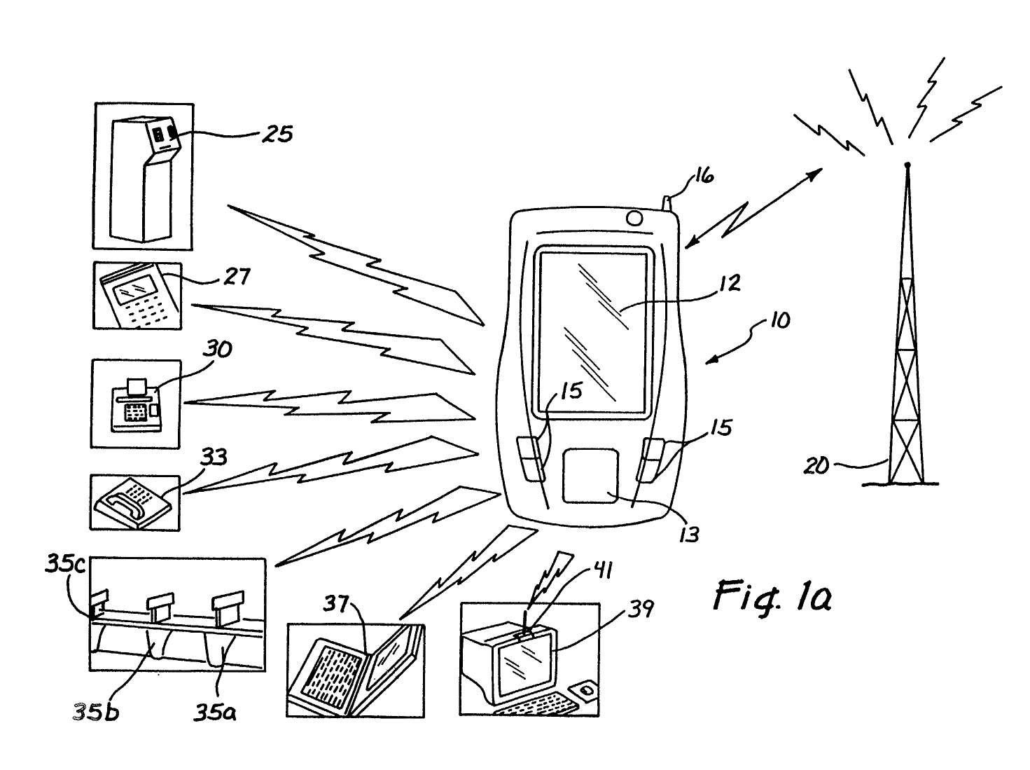

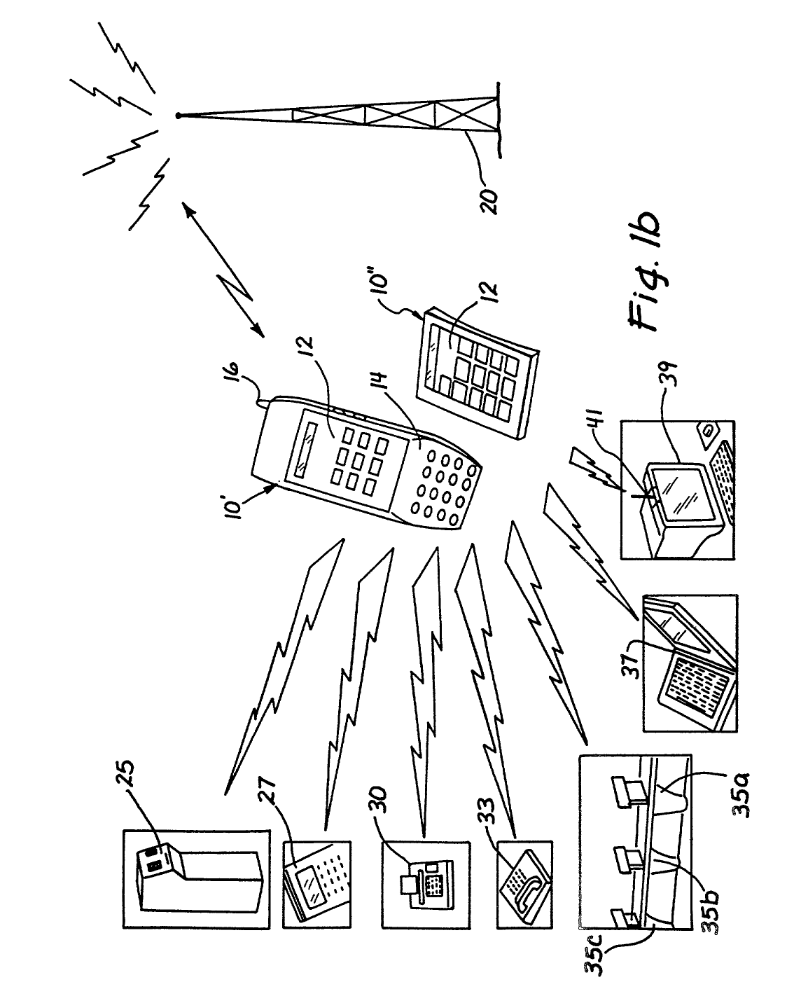

Referring more particularly to the drawings, FIG. 1a illustrates an external view of a consumer touchpoint device 10 in accordance with a presently preferred embodiment of the present invention. The consumer touchpoint device 10 is preferably implemented as a small, self-containing package that is sufficiently ruggedized for daily use in the field. Preferably, the consumer touchpoint device 10 is small enough to be comfortably carried with the user at all times, e.g., as a key chain attachment or a small package that can easily fit inside a purse or a wallet.

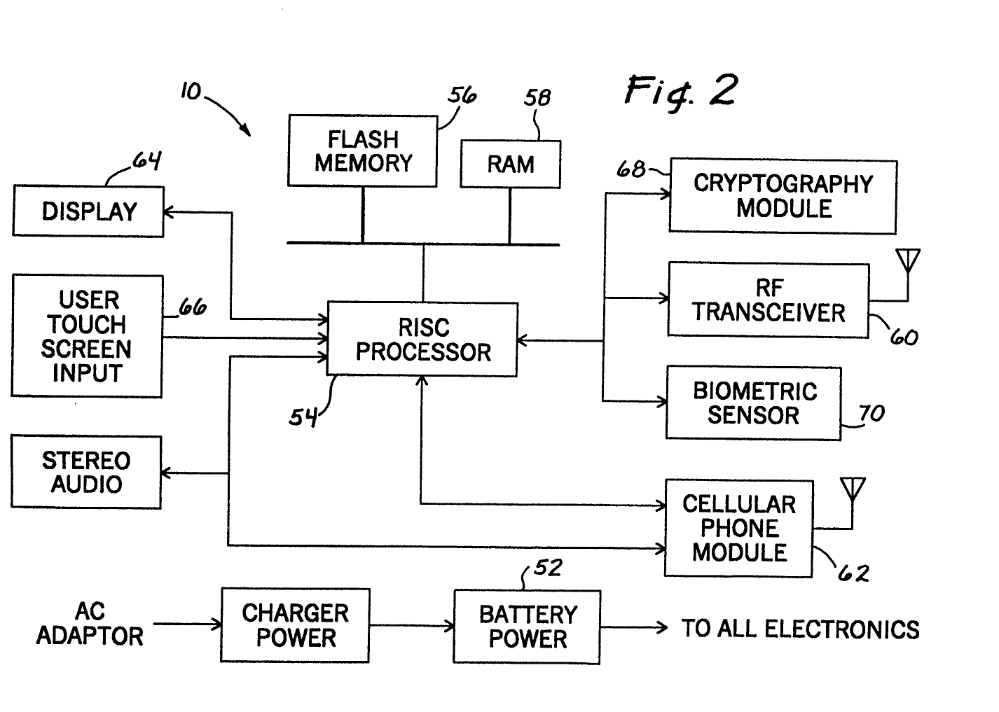

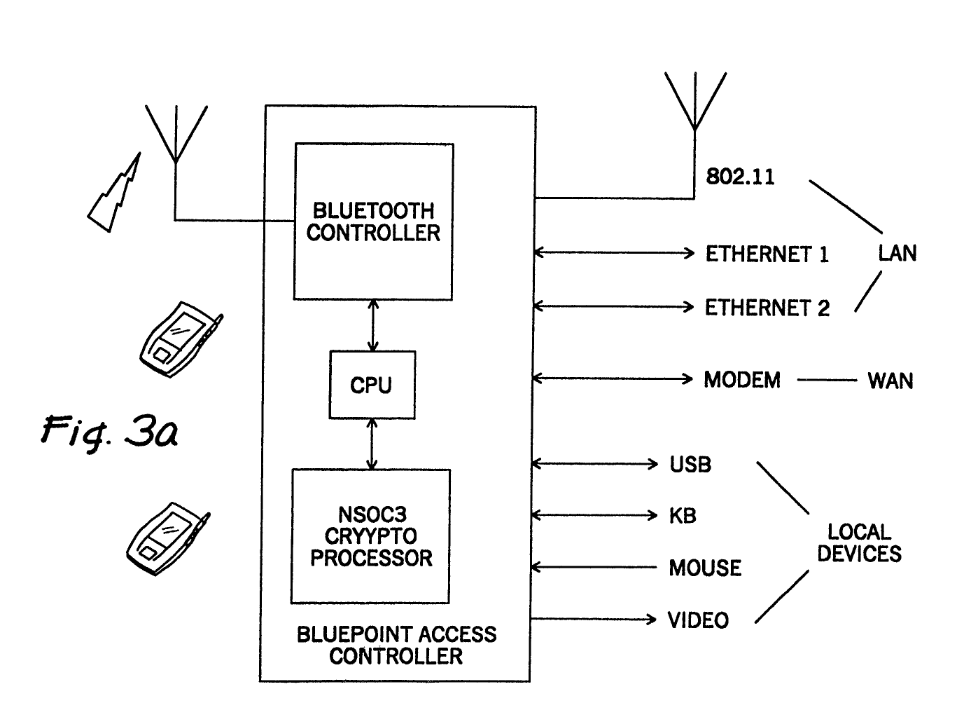

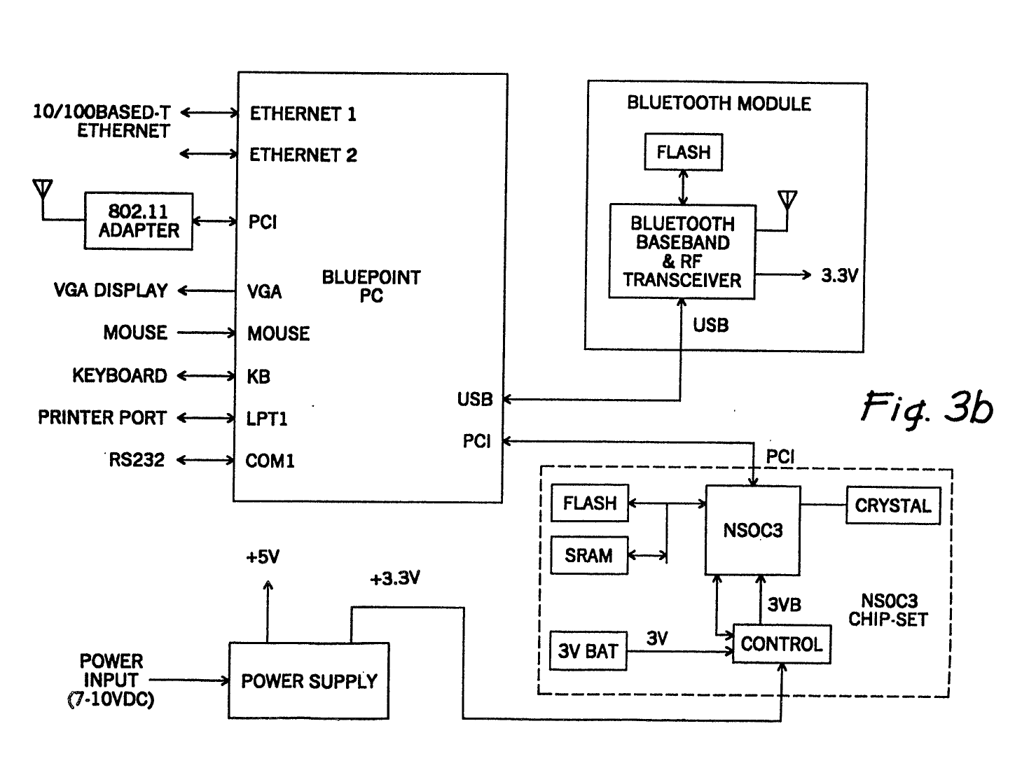

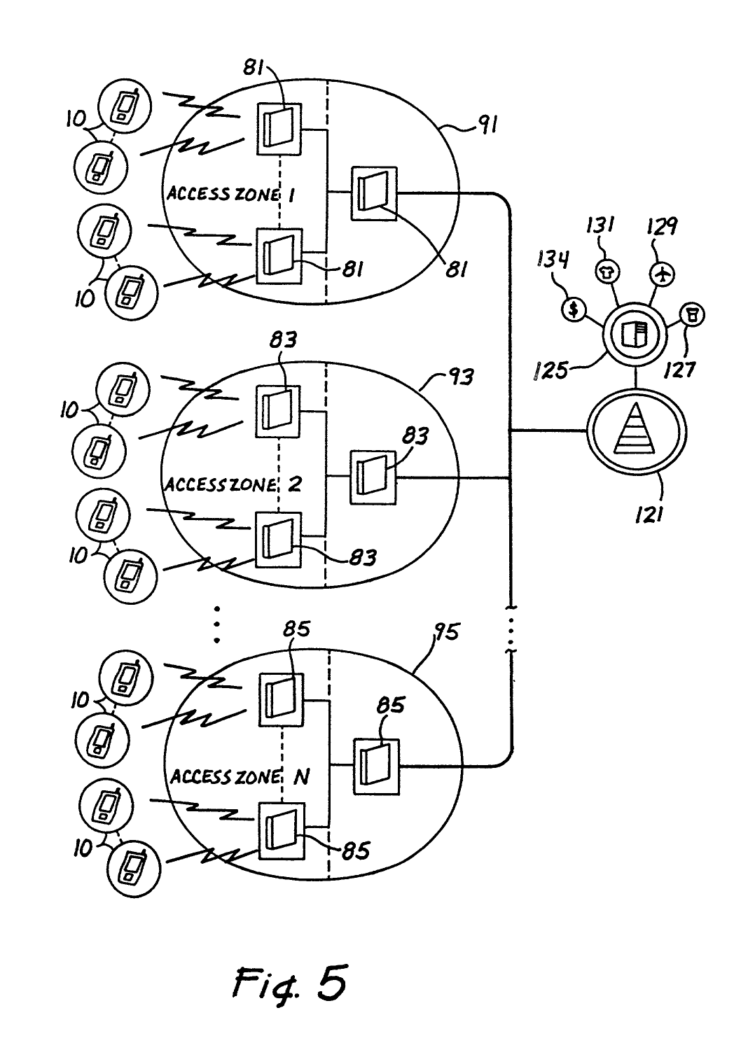

The consumer touchpoint device 10 comprises a display and input device such as a touchscreen 12, a biometric sensor 13, navigation buttons 15, an antenna 16 for wireless communication with a cellular tower 20, and a low power radio frequency (RF) transceiver 60 (FIG. 2) for communicating with at least one access controller 81 (FIG. 5). As shown in FIG. 1a, the touchscreen 12 is preferably disposed on an upper portion of the consumer touchpoint device 10, and preferably comprises a display screen such as a liquid crystal display (LCD). The display screen preferably comprises a 16 level grayscale, 320×240 pixel LCD with a backlight, but alternatively may comprise a gas plasma display or other type of suitable display. Although gas plasma displays may produce very sharp monochrome images, they require much more power than the presently preferred low power LCD displays. As presently embodied, the touchscreen 12 facilitates input via a user's finger or an attached stylus. The consumer touchpoint device 10 preferably comprises an integrated personal digital assistant (PDA).

FIG. 1b illustrates a consumer touchpoint device 10′ having a similar construction to that of FIG. 1a and further including a keypad 14. In the illustrated embodiment wherein the consumer touchpoint device 10′ is integrated into a PDA and a wireless phone, the display 12 is the display on the portable phone and the keypad 14 serves as the keypad for the wireless phone. The touchscreen 12 of the consumer touchpoint device 10 is similarly constructed, with the touchscreen 12 serving as the keypad for the wireless phone.

Another consumer touchpoint device 10″ is illustrated in FIG. 1b having a size comparable to that of several stacked credit cards. The consumer touchpoint device 10″ in the illustrated embodiment is similar to that described in connection with FIG. 1, but preferably does not comprise a cellar phone. In a modified embodiment with advanced components, the consumer touchpoint device 10″ may comprise a cellular phone as well.

Another embodiment of a consumer touch point device (“m-Engine™”), which can be utilized for both on-line and off-lie operations, is disclosed below. The m-ENGINE™ will be used as the building block of computer platform for CDL Inc. product lines. The target application is m-lD™, m-MODEM™, m-PHONE™, m-PAD™ and other products that will require the processing power and encryption of Personal Identification Number (PIN) as well as the LCD display.

The m-ENGINE is the core component for CDL's mobile product line. Refer to specification 14-010000-001 for details. The operating system is Acer/CDL linux version. The software architecture of the m-ENGINE consist of a few main components; Acer/CDL embedded Linux kernel, which includes all the device drivers, database, bluetooth, networking, biometric, encryption, and windowing system.

The m-ENGINE™ will be designed to meet the ISO-9564 Standard for Personal Identification Number (PIN) security. A proprietary hardware assisted encryption processor (RSA) may be used to store encryption algorithm and encryption keys in the encryption form. ANSI PIN Block and DES PIN/Pad PIN Block formats will be supported.

If external memory (SRAM) is used to store the encryption processor program and data, a battery backed 128-bit key is stored in a special key register internal to the RSA encryption processor. The key is created from a random number generator internal to the encryption processor at boot time. This key is random and unknown to the user. The program and data of RSA encryption processor are stored with this encrypted key. This will make program and data secure to bus analyzers.

The PIN being transmitted to the host will be encrypted by a software algorithm, and the key will be stored in the encrypted SRAM. The master key used for encryption will be loaded at the installation by means of an operator initiated registration process. The keys used for PIN encryption are loaded at run time through a run time exchange process. Protective covers will almost completely enclose the m-ENGINE™ to protect from tampering and tapping. Switches will detect the disassembly of the m-ENGINE™ and will cause a loss of all keys and algorithm. The packaging of the m-ENGINE™ will also use non-removable security seals as a visual indicator for disassembly.

The following software functional requirements apply to the m-ENGINE™ system, which consists of a computer main board, encryption, LCD, and touch panel. References made to FIG. 8.

The linux kernel is 2.2.1 compatible. The development platform will initially be on the Cirrus Logic 7211 evaluation hardware kit. Standard drivers supported are LCD with 16 level of gray, touch panel, keypad, serial, TCP/IP, PPP, system real-time clock, Micro-timer, and Power management.

The software libraries interface with the device drivers in the kernel to provide an abstraction layer to the applications.

The Bluetooth driver expose a virtual COMM interface to the upper layer. Service Discovery Profile Application will be implemented as a background task. Bluetooth events will be handled by the event handler.

MicroGUI is based on Microwindows Open Source project aimed at bringing the features of modern graphical windowing environments to smaller devices and platforms. Microwindows allows applications to be built and tested on the Linux desktop, as well as cross-compiled for the target device. The APIs is Win32/CE like.

A database engine is utilized both for on-line and off-line operations. Limited transactional activities are allowed in off-line mode where information is queued up and delivered when connection to CDL networks permits. The database engine also allows data synchronization to the CDL networks.

Biometric finger print interface to the m-ENGINE via a UART communication port. The image of the finger print is captured, encrypted then send to the CDL portal for identification.

The m-ENGINE™ shall provide circuitry to support power management. The power management circuitry shall include battery monitoring, and low power standby by enabling and disabling power to peripherals that are either internal or external to m-ENGINE™.

Power management are implemented in three level; Bluetooth, OS, and application. This section addresses the power management of the m-ID™ which includes the m-ENGINE™ and the m-CONNECT™.

Before joining a piconet, m-CONNECT™ module is in standby mode. In this mode, an unconnected unit wakes up and listens for messages every 1.28 seconds. Paging messages are transmitted on 32 of the 79 hop carriers which are defined as wake-up carriers. A connection is made by a page message if the address is already known. Otherwise, an inquiry message followed by the next page message if the address is unknown.

The wake-up sequence is transmitted over the 32 wake-up carriers. Initially, the first 16 hop carriers are used, if there are no response then the rest of the carriers are used. The slave (m-ID™) listens for 18 slots on the wake-up carrier and determines the incoming signal with the access code derived from its own identity. If there's a match, the unit invokes a connection-setup-procedure and enter Connected mode.

To connect units with an unknown address an inquiry signal is transmitted initially. This signal is used to inform the master unit of the slave's identity within transmission range. The paging unit on the inquiry wake-up carriers sends an inquiry access code. Units receiving this message response with their identity and system clock.

Three different power saving mode have been defined—Hold, Sniff, and Park. They can be used if there's no transmission ongoing in the piconet.

Hold: A slave (m-ID™) can request to be put on hold or be set to hold mode by the master (m-MODEM™ or m-ADAPTER™). In the hold mode only an internal timer is running. Data transfer restarts instantly when the unit transition is out of the Hold mode.

Sniff: a slave listens to the piconet at reduced rate, thereby reducing its duty cycle.

Park: the unit remains synchronized in the piconet but does not participate in the traffic.

Power management in the m-ENGINE™ is handled at 2 levels—OS and Application. Embedded into CDL/Acer Linux OS is a module that handles the different operating modes of the Cirrus EP7211 chipset—74 Mhz full operating mode, 18 Mhz low power mode, idle mode, and standby mode.

74 Mhz consume 170 mW

18 Mhz consume 50 mW

Idle mode consume 15 mW (clock to the CPU stopped but everything else running)

Standby mode consume 10 uW (real time clock running but everything stopped)

Typically, the m-ENGINE™ is in standby mode, only the clock running. Types of events that wake it up are Bluetooth event, user input events (touchscreen, keyboard, etc . . . ), and soft-events. At the application level, power management is handled by polling data of the user's profile database, user's preference setting, and CDL preset configurations.

Different types of application required different CPU operating mode. PDA type applications require the CPU to run at 18 Mhz. Transactional, security type of application that requires authentication would need the CPU to run at full speed (74 Mhz).

This section describes the applications on the m-ENGINE.

When the m-ENGINE first power on, it will go through self-test, screen-calibration, and user personalization. References made to FIG. 9.

The user will be required to go through a local sign-on process where the m-ENGINE prompts for password/PIN and necessary information. The user would be asked to have his/her picture taken, which would then be send to the m-ENGINE. References made to FIG. 10.

The m-ENGINE will communicate with the CDL Bluetooth access point which could be m-MODEM which then dial out to CDL network. A Terminal Identification number is then assigned to the m-ENGINE unit from the back-end. The user would then be prompted for banking, travel, billing, etc . . . References made to FIG. 11.

This section describes the communication system on the m-ENGINE. This include communication protocols to the handset module, m-CONNECT, and the m-MODEM. References made to FIG. 12.

At the initial power up of m-ENGINE™, the NMEDCHG pin must be tied to low to force the EP7211 micro booting from internal on-chip Boot ROM. The WAKEUP pin must be asserted from low to high in order for the boot up sequence to start. The 128 bytes of on-chip Boot ROM sequence will be utilized for initializing EP7211 micro and the UART1 to receive initial 2048 bytes of serial data that will be placed in the on-chip SRAM. When the initial upload is complete, the program will jump to the start of the on-chip SRAM and begin the execution. This program will allow the diagnostic program to be uploaded to DRAM and perform a pass or fail diagnostic test of the m-ENGINE™ internal peripherals and devices. The diagnostic tests of m-ENGINE™ will include the following tests:

Memory tests—internal SRAM, DRAM and Flash

LCD—may require technician visual inspection of display data on LCD

Touch Panel—may require test technician intervention

Keyboard—may require test technician intervention

Timer and interrupt

Loop back tests of UART 1-3

Read/write test to RSA encryption processor

After successful diagnostic test of m-ENGINE™, recycle power to m-ENGINE™ with the NMEDCHG pin tie to low to force the EP7211 micro booting from internal on-chip Boot ROM. The WAKEUP pin must be asserted from low to high in order for the boot up sequence to start. The 128 bytes of on-chip Boot ROM sequence will initialize EP7211 micro and the UART1 to receive 2048 bytes of serial data that will be placed in the on-chip SRAM. When the initial upload is complete, the program will jump to the start of the on-chip SRAM and begin the execution. This program will allow the OS and application to be uploaded to program the system Flash. Refer to EP7211 data specification for more detail operation.

The m-ENGINE™ hardware shall be able to support firmware/software upgrade through the m-CONNECT™ Bluetooth RF module connection. When software upgrade is needed, the updated software will be downloaded through the m-CONNECT™ wireless link to the system DRAM. The Flash will be updated when the complete downloaded file in DRAM is checked and free from any errors.

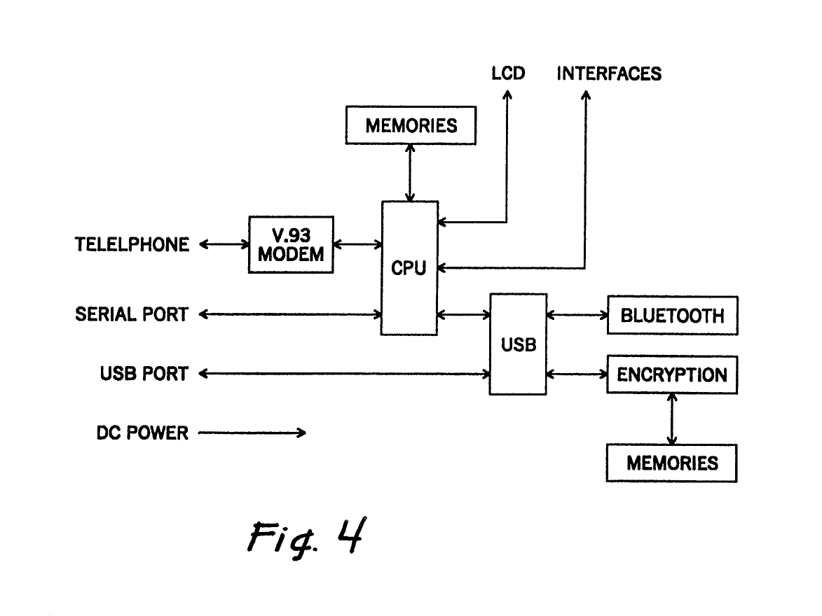

Each access controller 81 (FIG. 5) comprises a corresponding low power RF transceiver for communicating with the low power RF transceiver 60 (FIG. 2) of the consumer touchpoint device 10, and further comprises a network connection for communicating with a back-end knowledge center 121 (FIG. 5). A key element of the access controllers of the present invention is their relatively low energy usage (e.g., for compactness and portability) and their relatively low cost (for quantity). Since the invention works best with a large number of access controllers, it is preferred in accordance with one aspect of the present invention that relatively low-power transmissions be used. This feature will help to promote the transition to a large number of access zones. One intuitively might select an RF technology utilizing high power transmissions. It is presently preferred for one exemplary embodiment to have RF transmissions that range in radius from about 100 m in range or less, and more preferably, less than about 15 m radius RF Transmissions. In the presently preferred embodiment, the access controllers are integrated into or connected to a variety of electronic devices to allow the consumer touchpoint device 10 to communicate with the knowledge center 121 over a relatively large range of transactional and geographical applications. In the illustrated embodiment of FIG. 1, access controllers (e.g., FIG. 4 or 81 of FIG. 5) are incorporated into or connected to numerous electronic devices to thereby form an automated teller machine (ATM) access controller 25, a point of sale (POS) access controller 27 placed at a physical location at which goods are sold to consumers, a boarding gate access controller 30, a home/hotel telephone access controller 33, a bank teller access controller 35a, a laptop or other portable computer access controller 37, and a personal computer (PC) access controller 39.

In the illustrated embodiment, the PC access controller 39 comprises a free standing access controller 41, which can be connected to the PC via a USB, serial, PC card, or other input/output (I/O) port of the PC. Similarly formed free standing access controllers may be connected to I/O ports of any of the above-mentioned or other electronic devices as a convenient, inexpensive conversion of those electronic devices into access controllers.

Each of the access controllers is either directly or indirectly connected to the knowledge center 121 via a telephone line, communications cable, or other communications link, via (1) another access controller, or (2) a computer, e.g., a PC or laptop, which in turn is connected to a telephone line, communications cable, or communications link. As presently embodied, the access controllers in a certain geographical vicinity are all connected together via, for example, their low power RF transceiver s to form a Local Area Network (LAN), and at least one of the access controllers in the LAN is in turn connected to a telephone line, communications cable, or other communications link for providing all of the access controllers on the LAN with access to the knowledge center 121.

In a preferred embodiment, the access controllers of a LAN are connected together via a hub to form an Ethernet, and one of the access controllers on the Ethernet is connected in turn to a communications cable for accessing the knowledge center 121. In this embodiment, the one access controller, in addition to serving as a gateway to the knowledge center 121, is configured to coordinate the operations of the other access controllers on that Ethernet. As presently embodied, each access controller is configured to support up to 30 consumer touchpoint devices and to accordingly perform intra-networking functions among the various consumer touchpoint devices being supported at any given time.

In the illustrated embodiment, each access controller regularly reports to the knowledge center 121 the identifications (y-TINs, defined infra) of the particular consumer touchpoint devices with which the access controller is presently in communication. The knowledge center is thus able to track the location of each consumer touchpoint device 10 by monitoring the access controller(s) with which the consumer touchpoint device 10 is presently in communication. In another embodiment, the access controllers of each access zone regularly report to the coordinating access controller of the access zone the identifications (y-TINs) of the particular consumer touchpoint devices with which the access controllers in that access zone are presently in communication, and the coordinating access controllers regularly report the information to the knowledge center 121. The knowledge center is thus able to track the location of each consumer touchpoint device 10 by monitoring the access zone with which the consumer touchpoint device 10 is presently in communication.

In a preferred embodiment, the one access controller is connected to the knowledge center 121 via the Internet. In any event, the access controllers preferably can be managed remotely, over for example the knowledge center 121 network, from a management center via, for example, SNMP interfaces. The access controllers may further be monitored and managed through the knowledge center 121.

The Ethernet connecting the access controllers may comprise, for example, an Ethernet 802.3 (10/100 Base T) connection using RJ 45 connectors, or may comprise a wireless Ethernet 802.11 system utilizing moderate range RF wireless connections. In another embodiment, a plurality of the access controllers in a vicinity are networked together via moderate range RF connections using a HomeRF protocol, which is sponsored by the HomeRF Working Group, Inc. and which may be implemented using, inter alia, BB160 PC Adapter cards and related components manufactured by Motorola, Inc. in alternative embodiments, connections can include wireless modems, other wireless LANs, wireless Personal Area Networks (PANs), cellular telephone networks, digital communication systems, etc. connecting the access controllers to one another.

The one access controller in the LAN that is connected to the telephone line, communications cable, or other communications link (directly or via a computer) may comprise, for example, a modem, a USB connection, or a serial port connection (e.g., RS-232) for providing a communication link of the access controller to the knowledge center 121. The bank teller access controller 35a, for example, may be connected to a serial port connection of a PC, and the PC may comprise a modem for providing a connection to the knowledge center 121. A number of other access controllers, such as a second bank teller access controller 35b and a third bank teller access controller 35c, are then connected to the bank teller access controller 35a via, for example, on an Ethernet. Each access controller may be formed within the electronic device or may comprise a configuration similar to the free-standing access controller 41. Free standing access controllers may be connected to, for example, an ATM, POS, boarding gate, telephone, bank teller, laptop computer or PC, to thereby form an ATM access controller 25, POS access controller 27, boarding gate access controller 30, telephone access controller 33, bank teller access controller 35a, laptop computer access controller 37, and PC access controller 39.

In applications wherein only a single access controller is used, i.e., the access controller is not provided on a LAN with other access controllers, the single access controller itself will of course need to be connected to the telephone line, communications cable, or other communications link (directly or via a computer). Such a single access controller may comprise, for example, a modem, a USB connection, or a serial port connection (e.g., RS-232) for providing a communication link of the access controller to the knowledge center 121. A modem access controller can be integrated into any of the above access controllers and, further, is provided in accordance with the present invention in a separate housing as a simple low cost unit.

The modem access controller, as illustrated in FIG. 4, preferably comprises a high-speed V.90 secured Public Switched Telephone Network (PSTN) dial-up device for providing access to the knowledge center 121. The term PSTN refers to the international telephone system based on copper wires carrying analog voice data. This is in contrast to newer telephone networks base on digital technologies, such as ISDN and FDDI. Telephone service carried by the PSTN is often referred to as plain old telephone service (POTS). The modem access controller further comprises a Bluetooth protocol RF Transceiver for communicating with consumer touchpoint devices 10. The modem access controller is thus able to interface with consumer touchpoint devices at one end using for example Bluetooth technology, and to interface with the PSTN through modem dial-up at the other end.

One embodiment of an access controller (“m-SYNC™”), which comprises a DKI Baseband Controller and Bluetooth Communication Port, is disclosed below.

This specification describes the functional, physical, electrical, interface and environmental properties of the m-SYNC™ Bluetooth RF module. The m-SYNC™ uses Bluetooth RF communication protocol.

The m-SYNC™ will be used as the building block of CDL Inc. product lines that require Bluetooth RF communication interface via an USB port. The target application is an aftermarket add-on device to the Personal Computer (PC) platform product lines and other products that will require the adaptation of Bluetooth RF communication protocol via an USB port.

The m-SYNC™ design is based on Domain Knowledge Inc. (DKI P/N) high performance Bluetooth Chipset. The m-SYNC™ consists of a DKI Baseband Controller and Bluetooth RF Transceiver. The m-SYNC™ communicates with PC through an USB serial communication Port.

Bluetooth is a short-range wireless, open standard. It is designed to operate in the unlicensed 2.4 GHz ISM (Industrial, Scientific, Medical application) band. The Bluetooth specification includes air interface protocols to allow several Bluetooth applications to communicate simultaneously.

Bluetooth Specification

| Range | 10 | meters |
|---|---|---|
| | (100 | m with amplifier) |
| Gross Bit Rate | 11 | Mbps |
| Max Data Rate - Symmetric | 432.6 | Kbps |
| Max Data Rate - Asymmetric | 723.2 | Kbps/57.6 Kbps |
| Max Voice Channel per Link | 3 | |
| Protocol | Switched/Packet Combination | |
| Max Piconet Population | 8 | |
| Radio Frequency | 2.4 | GHz (unlicensed band) |
| Frequency Hop Rate | 1600 | per second |
| Standby Mode Listen Rate | Every 1.28 | second |

The following functional requirements apply to the m-SYNC™ module. FIG. 13 shows the simplified m-SYNC™ System block diagram.

The m-SYNC™ module consists of 2 major functional blocks, Baseband controller and Bluetooth RF Transceiver. The m-SYNC™ connects to the host (PC) via an USB port. A standard USB interface is used for both data and data flow control.

The Baseband controller as a minimum must have USB interface. The m-SYNC™ USB shall be implemented as a master device. The USB interface is defined at the Table 1.

TABLE 1
m-SYNC ™ and m-SYNC ™ USB Interface Definition

| J1 | Signal | Direction | Polarity | Description |
|---|---|---|---|---|
| 1 | V_{BUS} | Output | Power | Bus Power |
| 2 | USB_D− | Bi- | Data − | USB Serial Data − |
| | | direction | | |
| 3 | USB_D+ | Bi- | Data + | USB Serial Data + |
| | | direction | | |
| 4 | GND | | Ground | Ground |

The Bluetooth RF Transceiver module is a short range 2.4-2.5 GHz radio transceiver for Bluetooth communication. The Bluetooth RF Transceiver shall comply with Bluetooth specification version 1.0.

The external dimensions and packaging of the m-SYNC module are portrayed in FIGS. 15 and 16.

The m-SYNC™ shall provide circuitry to support power management. The power management circuitry shall include control circuitry that will enable both the Baseband controller and RF Transceiver module in low power standby. Power management are implemented in three level; Bluetooth, OS, and application.

This section describes the software/firmware required to run on the m-SYNC™. There are two scenarios of partitioning the software between the m-SYNC™ and the m-SYNC™: the upper software stack (from HCI up to RFCOMM) to run on the PC as a Windows device driver, or the upper software stack to reside on the m-SYNC™. The second scenarios is preferred since it will keep the partition clean. With reference to FIG. 17.

m-SYNC™ gets the power via the USB connector. The maximum power consumption for the m-SYNC™ is TBD mA or less. When the m-SYNC™ is at low power standby mode, the power consumption shall be less than TBD mA.

The pin out of m-SYNC™ USB Interface Connector J1 is an USB Serial “A” Plug. The pin out of interface connector J1 is defined as in Table 1.

The m-SYNC™ module is an embedded processor/controller for CDL product lines. Although commercial and consumer grade components are utilized for the main board, the packaging must conform to product mechanical, environmental, and maintenance requirements.

The m-SYNC™ module circuit board shall be enclosed in a protective chassis, which provides a mounting structure, operator and maintainer controls and indicators, cooling, security, electromagnetic radiation suppression, and maintenance accessibility.

The m-SYNC™ module circuit board shall not exceed the external dimensions of 48×10 mm. Refer to FIG. 4 for detail.

The m SYNC™ in its protective case shall be able to sustain 3 G shock without damage.

An embodiment of a modem access controller which comprises a wireless modem utilizing Bluetooth technology (“m-Modem™”), is disclosed below.

The m-MODEM™ is designed based on the Domain Knowledge Inc. DKI P/N high performance Bluetooth chip-set and the V-90/ADSL modem chip. The m-MODEM™ consists of a main board, a Bluetooth RF antenna, a phone port, and a 56 K V-90/ADSL modem port. The main board hosts a DKI Base Band Controller, a Bluetooth RF Transceiver, and a V-90/ADSL modem.

The m-MODEM™ supports system commissioning functionality for system installer or user to set up configuration parameters, such as dial-up phone numbers, time-out value of end-to-end link idle time, location information of the m-MODEM, and modem related control parameters. Only authorized user(s) can activate the Configuration Function Interface.

A m-MODEM™ Registration Procedure, which uses the Configuration Function, is implemented by the m-MODEM for the system installer/user to connect the m-MODEM™ to the CDL network for registration. The registration process passes the m-MODEM™ location information and m-MODEM™ ID to the CDL Knowledge Center. The m-MODEM™ ID was stored in the boot ROM of the m-MODEM™ board by the manufacturer.

The following functional requirements apply to the m-MODEM™ module, which consists of m-CONNECT™ module (Bluetooth RF transceiver and Baseband controller), microprocessor and V.90 & ADSL modem. FIG. 18 shows the simplified m-MODEM™ System block diagram.

m-CONNECT™ Module comprises of two major components, Baseband Controller and Bluetooth RF Transceiver.

The Baseband controller as a minimum shall have an UART implemented. The UART shall be an industrial standard 16C550 compatible and it supports baud rate up to 460 Kbaud. The UART shall have a minimum of 16 bytes of FIFO. A standard UART interface shall be implemented with four signals; mC_TXD and mC_RXD are used for data flow, and mC_CTS and mC_RTS are used for flow control. The UART interface is defined in Table 1.

TABLE 1
2 m-CONNECT ™ and Modem DSP Interface Definition

| Signal | Direction | Polarity | Description |
|---|---|---|---|
| mC_TXD | Output | Data | Serial output transmit data from |
| | | | Modem DSP to m-CONNECT ™ |
| | | | Module. |
| mC_RXD | Input | Data | Serial input receive data from |
| | | | m-CONNECT ™ Module to |
| | | | Modem DSP. |
| mC_CTS | Output | High | Clear To Send from Modem DSP |
| | | | to m-CONNECT ™ Module. |
| mC_RTS | Input | High | Request To Send from m- |
| | | | CONNECT ™ Module to |
| | | | Modem DSP. |
| mC_RESET* | Output | Low | Master Reset, active low. When |
| | | | low the m-CONNECT ™ Module |
| | | | is held at reset stage. |
| VCC | Output | Power | Power supply voltage = 3.3 V |
| GND | | Ground | Ground |

USB interface shall be provided for the next generation of Baseband controller. The m-CONNECT™ USB shall be implemented as a slave device and the modem DSP is the USB bus master. The USB interface is shown at Table 2.

TABLE 2
m-CONNECT ™ and modem DSP USB Interface Definition

| Signal | Direction | Polarity | Description |
|---|---|---|---|
| mC_USBD+ | Bi-direction | Data + | USB Serial Data + |
| mC_USBD− | Bi-direction | Data − | USB Serial Data − |
| mC_RESET* | Output | Low | Master Reset, active low. When |
| | | | low the m-CONNECT ™ |
| | | | Module is held at reset stage. |
| VCC | Output | Power | Power supply voltage = 3.3 V |
| GND | | Ground | Ground |

The Bluetooth RF Transceiver module is a short range 2.4-2.5 GHz radio transceiver for Bluetooth communication. The Bluetooth RF Transceiver shall comply with Bluetooth specification version 1.0 B.

The modem chip set shall support both the analog V.90 and the ADSL (Digital Subscriber Line) formats. The modem DSP chipset shall be able automatically detecting the best connection at the central telephone site, whether it is a DSL or regular analog line.

The microprocessor, flash memory and RAM are used for the housing keeping for the modem. It shall be used to store the modem parameters such as the configuration, node ID, serial number, TIN, physical location, and other information.

The m-MODEM™ shall provide circuitry to support power management. The power management circuitry shall include control circuitry that will enable both the Baseband controller and RF Transceiver module in low power standby.

The following software architecture applies to the m-MODEM™ software system, which implements the Dial-up Networking Profile specified in the Bluetooth Specification Version 1.0 B. FIG. 2 shows the software system architecture. Data terminals with Bluetooth capability can connect to the Internet Service Provider (ISP) through m-MODEM™. Data terminal may be m-ID™, m-PAD™, m-PHONE™, or any other wireless device with Bluetooth Serial Port Profile support.

In FIG. 19, the shaded area indicates the Bluetooth Serial Port Profile stack, and the area enclosed in the dotted line indicates the solution provided by DKI.

The m-MODEM™ Bluetooth Serial Port Profile Stack is marked by the shaded area in FIG. 2. The m-MODEM™ Bluetooth Serial Port Profile Stack shall meet the RFCOMM Interoperability Requirements, the L2CAP Interoperability Requirements, the SDP Interoperability Requirements, the Link Manager (LM) Interoperability Requirements, and the Link Control (LC) Interoperability Requirements specified in the Serial Port Profile of the Bluetooth Specification Version 1.0 B. The mCM performs the Modem Configuration Function, the Dial-up Networking Service Function, and the m-MODEM™ ID Retrieval/Report Function. The mCM shall support the DevB portion of the Application Layer requirements specified in the Serial Port Profile of the Bluetooth Specification Version 1.0 B. The mCM maintains a state machine with four states: IDLE state, CONTROL state, CONNECTING state, and CONNECTED state. The state transition diagram is shown in FIG. 20.

The mCM is in the IDLE state when there is no Data Link Connection (DLC) exists over RFCOMM, and there is no Dial-up networking connection via V-90 modem either. In this state, the m-MODEM™ is waiting for a new data link connection on the RFCOMM session to be established, which is triggered by a remote device. Only in the IDLE state, a new DLC can be established. A new DLC request shall be rejected if the mCM is in CONTROL state, CONNECTING state, or CONNECTED state.

The mCM is in the CONTROL state when a new Data Link Connection on the RFCOMM session is established. In this state, the mCM shall be able to perform the Modem Configuration Function. The Modem Configuration Function may set up the V-90 modem control parameters, may store the Location Information and Dial-up phone numbers in the FLASH Memory, and may configure the time-out value for configuration as well as the time-out value for established but idle (no data transfer activity) link. In addition, the remote device may retrieve the m-MODEM™ ID stored in the boot ROM.

The Configuration Function shall support an user authentication scheme so that only authorized user can access the Configuration Function Interface.

The mCM is in the CONNECTING state when the Dial-up Networking Service Function is initiated, but has not yet received the CONNECT indication from the V-90 modem.

The mCM is in the CONNECTED state when the CONNECT indication is received from the V-90 modem and the DLC is still connected. In this state, the end-to-end connection is established, and the mCM is in the data pass-through mode.

To set up the end-to-end link, a thin protocol layer above the serial port emulation layer of remote mobile device must interface with the mCM of m-MODEM™ through a messaging interface, as shown in FIG. 21.

This message is sent by a mobile device to the m-MODEM™, requesting a Dial-Up Networking connection. A Data Link Connection over RFCOMM should exist before the Dial_Up_Network_Request message can be sent.

This message is sent by the m-MODEM™ to the mobile device from which a Dial_Up_Network_Request message was received. The m-MODEM™ sends this message to the mobile device after a dial-up network connection is successfully made through the V-90 modem.

This message is sent by a mobile device to the m-MODEM™, requesting close of the existing dial-up network connection.

This message is sent by the m-MODEM™ to the mobile device from which a Hang_Up_Network_Request message was received. The m-MODEM™ sends this message to the mobile device immediately after receiving the Hang_Up_Network_Request message.

This message is sent by a mobile device to the m-MODEM™, requesting retrieve the m-MODEM™ ID. There is no authentication required to retrieve the m-MODEM™ ID.

This message is sent by the m-MODEM™ to the mobile device from which a Retrieve_mMODEM_ID_Request message was received. The m-MODEM™ ID is contained in this message.

This message is sent by a mobile device to the m-MODEM™, requesting to set the configuration data. The configuration data may contain the dial-up phone numbers, time-out value of end-to-end link idle time, time-out value of the configuration process, location information of the m-MODEM™, and V-90 modem related control parameters. Authentication is required to set configuration info to the m-MODEM™.

This message is sent by the m-MODEM™ to the mobile device from which a Set_Config_Info_Request message was received. The m-MODEM™ sends this message after it completes the configuration.

This section describes the interface primitives between mCM and RFCMM.

This is the connection indication sent by the RFCOMM to the mCM when a new DLC is requested by remote mobile device. A DLCI is passed as parameter.

When the mCM receives the RFCOMM_Connect_Ind from RFCOMM, it sends the RFCOMM_Connect_Rsp as response. The RFCOMM_Connect_Rsp shall contain a status with value ACCEPT or REJECT. ACCEPT indicates to RFCOMM that mCM accepts this new DLC to be established. REJECT indicates to RFCOMM that mCM rejects the new DCL to be made.

The mCM sends RFCOMM_Disc_Req to RFCOMM to disconnect the specified DLC. DLCI is passed as parameter.

The RFCOMM sends RFCOMM_Disc_Cfn to mCM confirming that the disconnect of a specified DLC. DLCI is passed as parameter.

The RFCOMM sends RFCOMM_Disc_Ind to mCM indicating that the disconnect of one or multiple DLCS. Those disconnected DLCIs are passed as parameters.

This section describes the interface primitives between mCM and V-90 Modem Driver.

The mCM sends ModemDrv_Connect_Req to the Modem Driver, requesting the Modem to dial out.

The Modem Driver sends ModemDrv_Connect_Cfm to mCM, confirming that a dial-up network connection has been made.

The mCM sends ModemDrv_Disc_Req to the Modem Driver, requesting close of the dial-up network connection.

The Modem Driver sends ModemDrv_Disc_Cfm to mCM, confirming that the dial-up network connection has been closed.

The Modem Driver sends ModemDrv_Disc_Ind to mCM, indicating that the Modem has lost the dial-up network connection.

The V-90 Modem shall support the AT Command set and Results Codes specified in the Dialing And Control Interoperability Requirements of the Dial-up Networking Profile.

The m-MODEM™ shall have an external power supply (power cube transformer or similar unit) to power the unit.

The design of the m-MODEM™ module circuit board shall address functional requirements, assembly costs, maintainability, adequate cooling airflow for increased reliability, mechanical integrity, and EMI emission control.

The m-MODEM™ module circuit board shall be enclosed in a protective chassis, which provides a mounting structure, operator and maintainer controls and indicators, cooling, security, electromagnetic radiation suppression, and maintenance accessibility.

The above discussed access controllers, including modem access controllers, can be deployed into existing commerce systems such as set forth in FIG. 1 and further including, for example, computer terminals in a network, portable devices, and other electronic devices used in connection with the financial industry (e.g., securities trading), medical (e.g., hospitals), transportation, food (e.g., vending machines), petroleum (e.g., gas pumps), retailing, gaming (e.g., casinos), entertainment (e.g., convention centers), manufacturing (e.g., supply-chain management), educational (e.g., universities), telecom and mobile suppliers, media entertainment, law enforcement, government (e.g., automated library check-out terminals), and other industry sectors. In accordance with one aspect of the present invention, the access zones are particularly suited for residential, working, and densely populated areas where transactions are likely to occur. Businesses using the access controllers of the present invention can realize advantages such as expediting payment processing, reducing errors, tracking item-level movements and providing sales and promotion analyses.

Other electronic devices in addition to those illustrated in FIG. 1 may be configured to accommodate or be connected to access controllers 81, 83, 85. Access controllers may be placed in free-standing form at various locations, as well. For example, one or more free standing access controllers similar to the free-standing controller 41 may be placed, for example, in a sitting area of the boarding gate 30, or may be placed throughout the aisles of a department store, warehouse, or supermarket in combination with, for example, a point of sale 27 access controller. The above-discussed access devices, and their configurations and connections, may be used in whole or in part with the other illustrated and discussed embodiments of the present invention. In addition, all combinations of the presently disclosed consumer touchpoint devices, access devices, and electronic devices of the preceding paragraphs which are not mutually inconsistent or incompatible are also included within the scope of the present invention. A unifying principle in accordance with one aspect of the present invention is to provide a pervasive computer network of interconnected access devices for communicating with low-power consumer touchpoint devices via relatively low-power, short range RF transmissions.

FIG. 2 illustrates, in a simplified manner and in accordance with one aspect of the present invention, the hardware for implementing a consumer touchpoint device 10. Although illustrated in block diagram form, a high level hardware implementation of the consumer touchpoint device 10 may comprise combinations of, discrete logic, programmable logic, one or more application-specific integrated circuits (ASICs), or the like. The random access memory may comprise some form of random access memory (RAM) such as static RAM and/or dynamic RAM, and the flash memory 56 comprises some form of read only memory (ROM) which does not lose information, even when the power is turned off. The flash memory 56 can be implemented using other forms of non-volatile memory (NVM) such as electrically programmable read-only memory (EPROM), electrically erasable, programmable read-only memory (EEPROM), or the like. The ROM of course comprises comprises a ROM BIOS, which is used to store information for, inter alia, starting up the consumer touch point device 10. Moreover, other types of optical memory or magnetic memory may be employed in addition to or as an alternative to the mentioned memory components.

A battery 52 provides power to the circuitry of the consumer touchpoint device 10. A microprocessor 54 executes codes stored in flash memory 56 and employs random access memory 58 for the execution. The microprocessor 54 preferably operates on a Linux operating system. The random access memory may comprise static RAM or dynamic RAM, both of which are known in the art. In a preferred embodiment, the microprocessor 54, flash memory 56, random access memory 58, LAN and serial communication ports (not shown), display circuitry 64, and encryption module 68, for example, are implemented on a single chip. The cellular chipset 62 is configured to support voice and secure data communications via cellular and similar networks including GSM, CDMA and PHS. A short-range RF Transceiver, such as the Bluetooth module 60, and an optional cell phone chipset 62 are both coupled to microprocessor 54.

Communication of the consumer touchpoint device 10 to and from cellular towers and access controllers is accomplished under control of microprocessor 54 via the Bluetooth module 60 and the cell phone chipset 62, respectively. As presently embodied, the consumer touchpoint device 10 can access the Internet and the knowledge center 121 through either the cellular or Bluetooth channels. The flash memory 56 preferably comprises an HTML browser for accessing the Internet and reading E-mail, stock quotes, weather, scores, etc. By way of example, computer languages such as Java by Sun Microsystems Inc. of Mountain View, Calif. or ActiveX by Microsoft Corp. of Redmond, Wash. or HDML (Handheld Device Markup Language) by Unwired Planet, Inc. of Redwood City, Calif., may be employed as well. The display circuitry 64 controls the display 12 of FIG. 1, and the user input circuitry 66 controls and corresponds functionally to the keypad 14 of FIG. 1. As presently embodied, the knowledge center 121 is configured to dynamically transform any standard HTML web page and to deliver the converted content as either HTML, or CHTML (Compact HTML) for HTTP devices or as WML for WAP (Wireless Application Protocol) devices, thereby reducing the need to create device specific pages or web sites for the consumer touchpoint device 10.

The Bluetooth module 60 in accordance with the present invention utilizes Bluetooth technology, which is a low-powered, short-range, cable replacement, radio technology system that allows products containing Bluetooth technology (see www.bluetooth.com) to be interconnected via wireless communication. Bluetooth uses the 2.4 GHz Instrumentation, Science, Medical (ISM) unlicensed band. The RF transceivers of the consumer touchpoint devices and the access controllers are preferably set to a nominal range of 10 meters. In accordance with a preferred embodiment, they are set to have a range of 15 meters, for a resulting 30 m radius of coverage for each access controller. A spectrum of hop frequencies are utilized beginning at the lowest frequency which is 2402 MHz and each of the hop frequencies is 1 MHz above the next lower frequency. A connection may be made between the two RF transceiver s by sending a page message. Such a page message can include a train of 16 identical page messages on 16 different hop frequencies. Packet data transmitted is preferably TCP/IP based. The system may use a Synchronous Connection Oriented (SCO) link for point-to-point, full duplex links, normally used in voice communication. For the application described herein, the Asynchronous Connectionless Link (ACL) may be used. ACL provides one frame duration links with full duplex communications. ACL communications use a time division duplex scheme. A first slot provides a transmission from the master to the slave and a second slot provides a transmission from the slave to the master. Each slot is transmitted on a different hop frequency. The device initializing the transmission is designated the master and the device receiving the transmission is designated the slave. Of course, the Bluetooth module 60 will allow the consumer touch point 10 to communicate with other Bluetooth enabled peripheral devices, including modems, printers and the like.

Strong end-to-end security protection between the consumer touchpoint device, access controllers, and the knowledge center 121, is preferably harnessed to insure maximum privacy and security for consumers and businesses. Accordingly, both the consumer touchpoint devices and access controllers are preferably constructed with hardware encryption technologies for secure identification, authentication and content protection. In accordance with the illustrated embodiment of FIG. 2, the encryption module 68 implements system-on-chip cryptographic ASIC and customized security software, including FIPS and X9 Financial approved algorithms including Triple-DES, Diffie-Hellman, a Digital Signature Standard (DSS), a Secure Hash Algorithm (SHA-1) and a Non-deterministic Random number generator.

The consumer touchpoint device 10 may require the user to enter a password or PIN via the touchscreen display 12, and further to furnish a fingerprint or a voice print, or other biometrics and/or identifying characteristics specific to the authorized user, such as the user's signature, user's facial image, DNA coding sequence through a tissue sample, before the consumer touchpoint device 10 can be activated and employed for conducting certain transactions. The password or other identifying information/characteristics may in modified embodiments include any of the above items and user's name, birth date and social security number, used alone or in various combinations.

It is noted that the public at large has generally accepted the fingerprint to be a proven and simple method of positive identification. The biometric sensor 13 of the present invention allows the user to voluntarily submit her fingerprint in a non-invasive manner. The biometric unit 70 of FIG. 2 is thus provided for working in combination with the other components including the encryption module 68 to provide secured transactions. As presently embodied, the biometric sensor 13 and biometric module 68 comprise an AES4000 EntrePad from AuthenTec, Inc. The AES4000 is based on low-cost CMOS (0.6 micron) semiconductor technology and comprises a small 20 mm by 20 mm by 1.4 mm surface mount package.

The consumer touchpoint device 10 is rugged and, importantly, in keeping with a requirement of one aspect of the present invention, has a relatively low power consumption. The AES4000 projects an array of low-power signals, which is focused just below the skin surface, beneath any finger surface contaminations (such as dirt, oil, water and chemicals) and dried, worn-out cuts or abrasions to the skin, to create an electronic image of the finger. The biometric unit 70 then process the scanned information and extracts relevant information including ridge patterns and minutia points. An extraction algorithm is used to produce a reduced data set or template. In modified embodiments, the biometric sensor 13 may comprise a thermal silicon fingerprint sensor or a capacitive silicon finger print sensor.

In accordance with an aspect of the present invention, the biometric sensor 13 and biometric unit 70 provide a high level of protection of consumers' identification information within the consumer touchpoint device 10 and during transit of information from the consumer touchpoint device 10 for authentication. Thus, users of the consumer touchpoint device 10 need not memorize a PIN, password or pass phrase to gain access to secure financial services, and are provided with fast, easy and accurate fingerprint entry procedure with Triple-DES hardware encryption prior to transmission.

The fingerprint scan, and the reduced data set or template, are preferably not stored in the consumer touchpoint device 10, but are stored only at a secure server. For instance, the encryption module 68 encrypts the reduced data set or template, along with authentication data, and transmits the resulting encrypted information via the Bluetooth module 60, for example, for processing. Since the information is encrypted, transmitted and processed, and not stored, replay, tampering, stolen identity and fraud are attenuated or eliminated. In a preferred embodiment, the secure server is connected behind the knowledge center 121. Thus, a fingerprint cannot be lifted, stolen and/or appropriated by another person from a lost or reverse-engineered consumer touchpoint device.

The physical enclosure of the consumer touchpoint device 10 can be arranged in one embodiment such that the content will be tamper-proof, i.e., if it is opened in an unauthorized manner any private information (e.g., the y-TIN, discussed infra) of the user will be destroyed and/or the consumer touchpoint device 10 will no longer be able to routinely function. By way of example, the enclosure may be arranged such that if it is opened, a change in the flow of current in a current path occurs, e.g., either the existing current flow is interrupted or a current path that has been idle starts to flow. The change in the flow of current may then send a distress or alert signal and/or reset the circuitry, including erasing any proprietary information within the memory. An approach for addressing the concern of unauthorized alteration of configuration or other sensitive data may be addressed by implementing within the consumer touchpoint device 10 memory that can be written only once such as PROM (programmable read-only memory), WORM (write once, read many), or the like, the security consideration associated with unauthorized alteration of configuration data is substantially eliminated.

FIG. 5 is a schematic representation illustrating a first set of access controllers 81 defining a first access zone 91, a second set of access controllers 83 defining a second access zone 93, and an Nth set of access controllers 85 defining an Nth access zone 95. Each of the access zones 91, 93, 95 may comprise, for example, from one to about 30 access controllers, and is defined by the cumulative coverage area of low power RF (e.g., Bluetooth) signal from the access controllers in that access zone. The access zones 91, 93, 95 may have circular or oval shapes for example, and may be configured to overlap one another for reasons including tighter or more complete coverage of a given area. For example, access zones may be placed in overlapping disposition to substantially cover the consumer walkways through the aisles of a grocery or department store.

In the illustrated embodiment of FIG. 5, each of the access zones comprises a plurality of networked access controllers 81, 83, 85 that are connected via single access controllers 81′, 83′, 85′ to the knowledge center 121 via a WAN. Since the access zones are defined by the presence of access controllers, the access zones are thus provided at homes, work, and within public areas, preferably public areas of commerce which include POSs, ATMs, airports and shopping centers. The access zones are networked through the knowledge center 121 back to, for example, existing web applications and sites 125, including those of businesses and other entities 127 in the categories of financial, services (e.g., transportation) 129, retail 131, and other existing transaction systems 134.

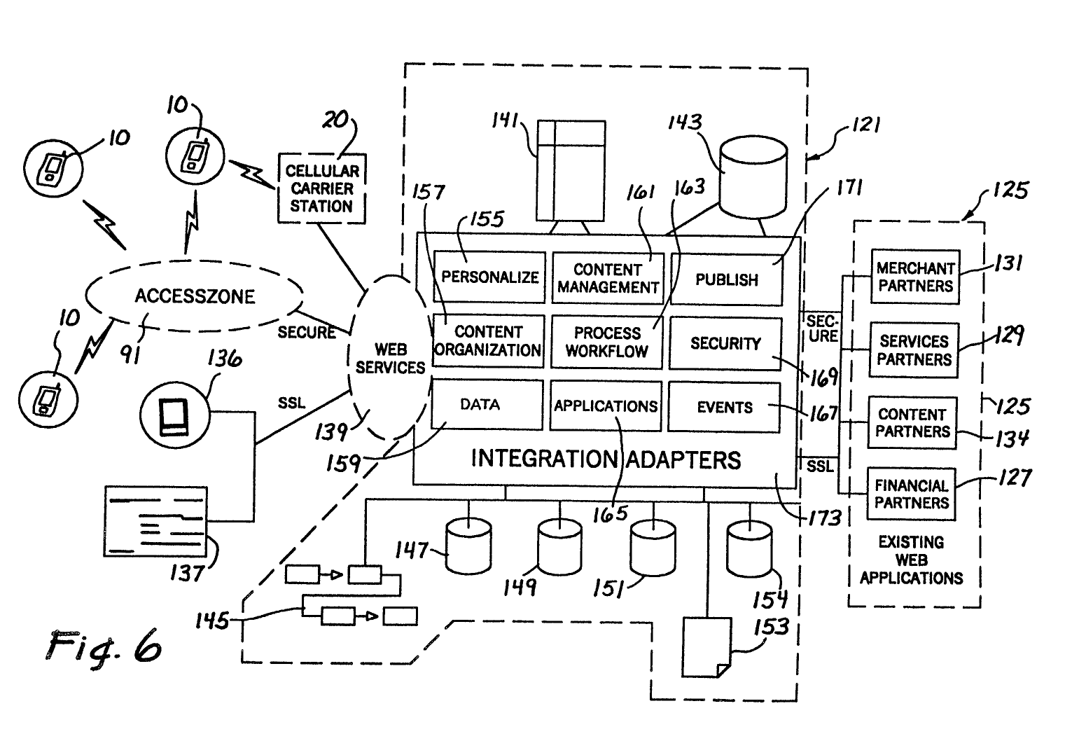

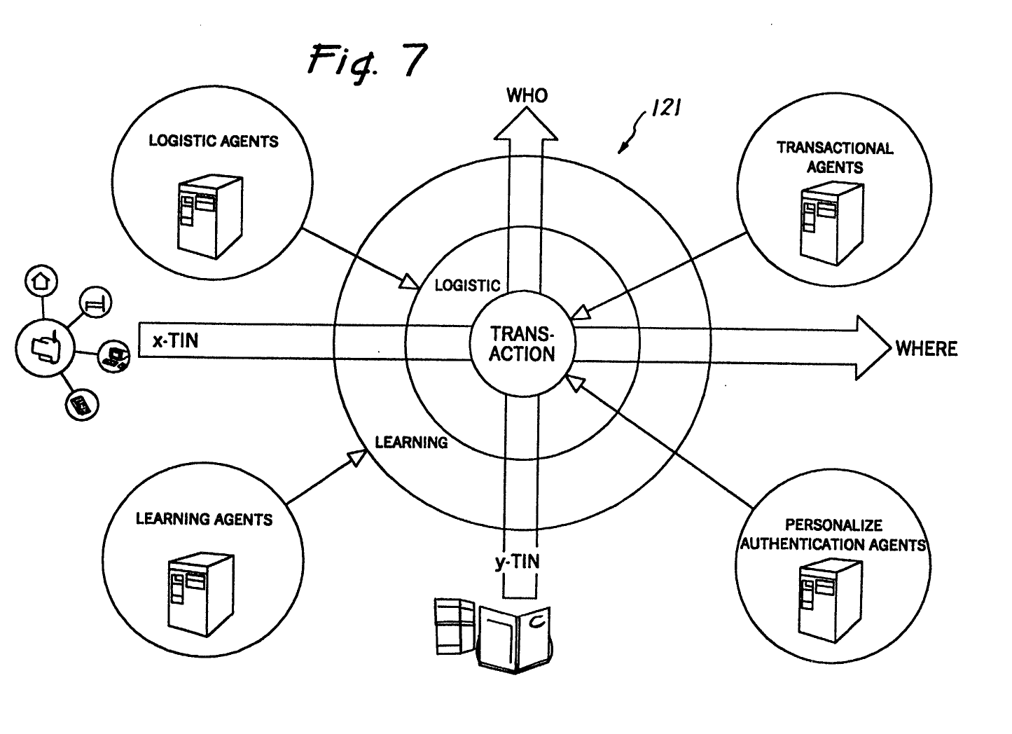

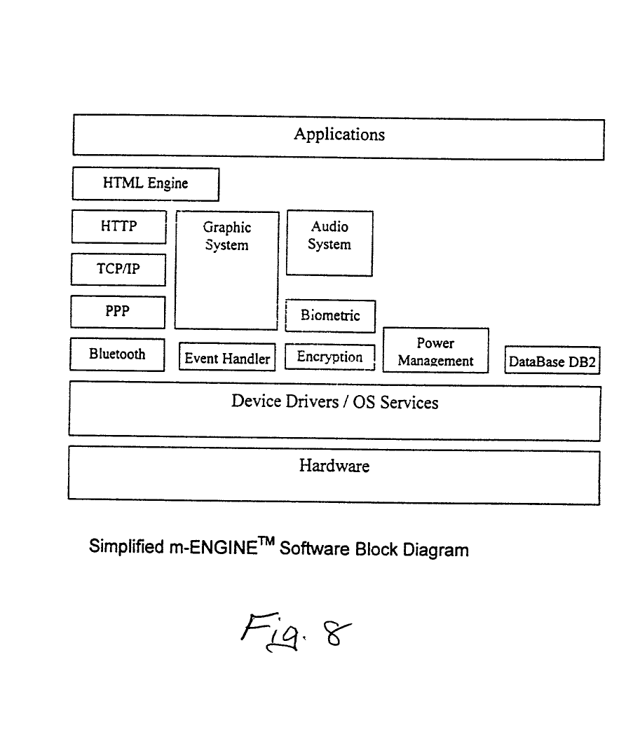

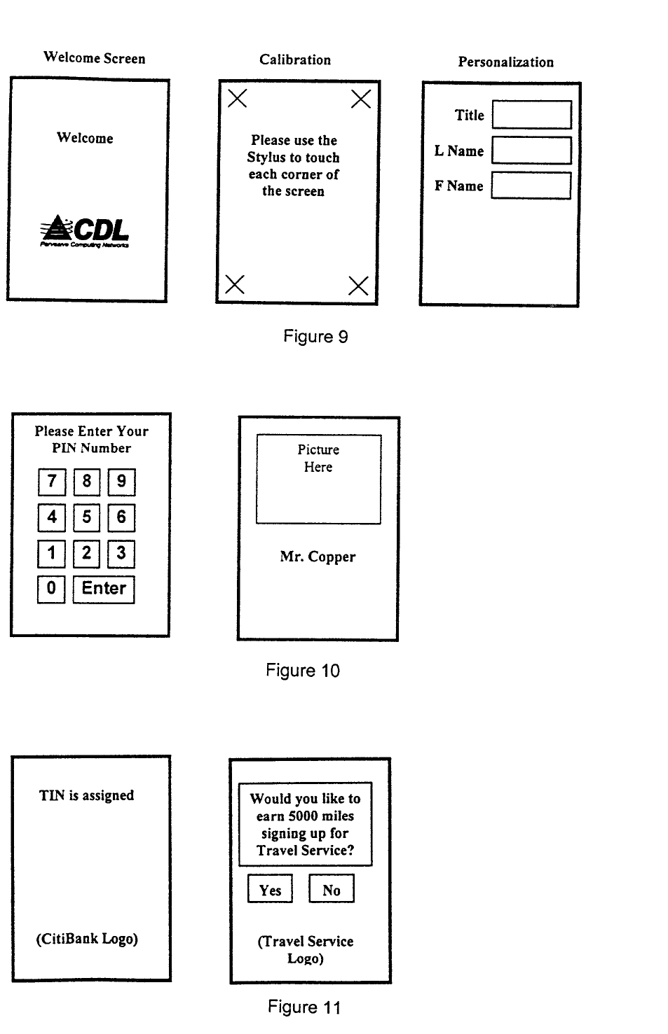

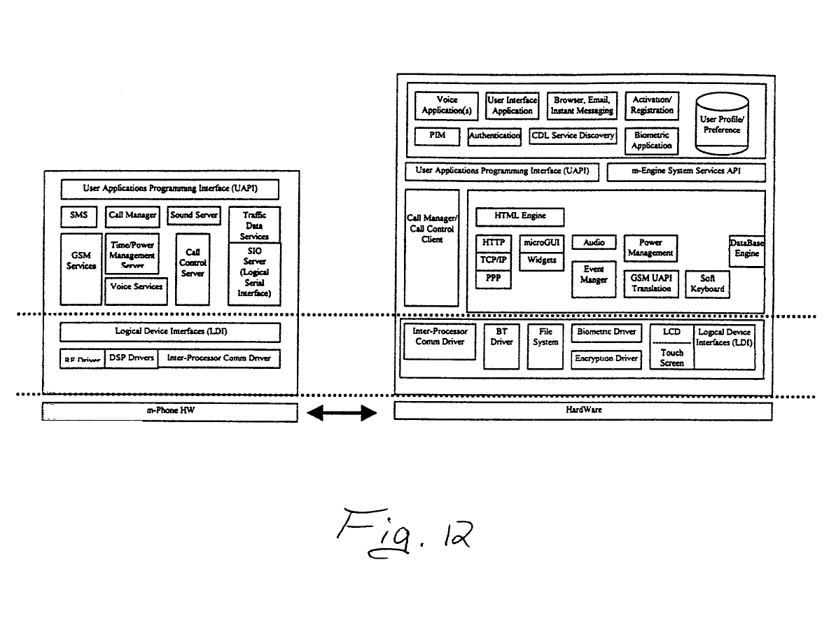

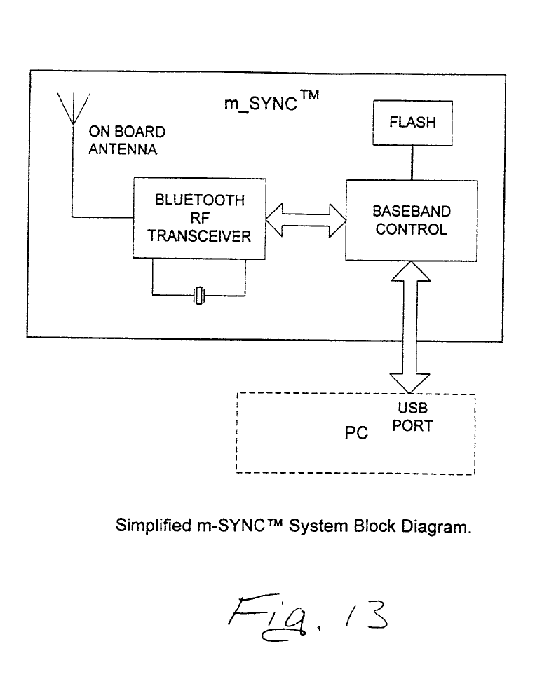

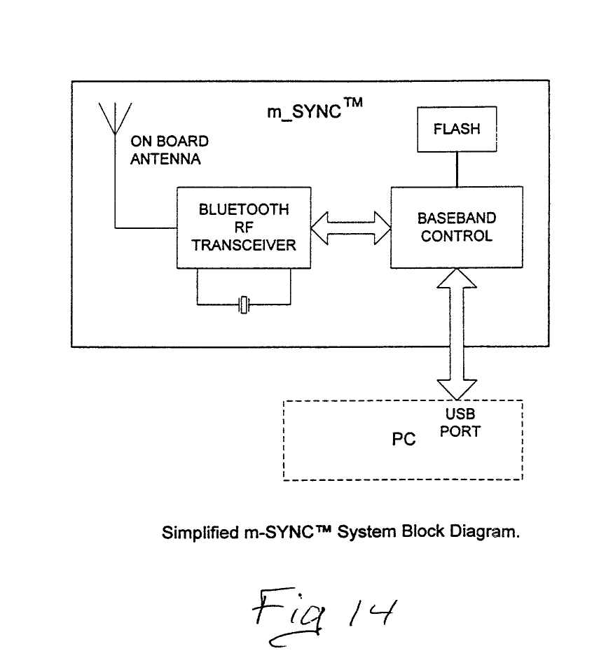

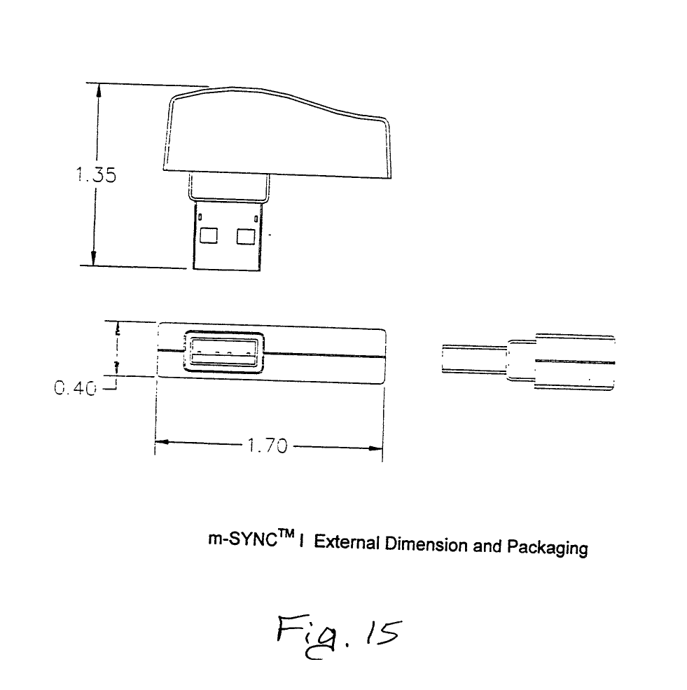

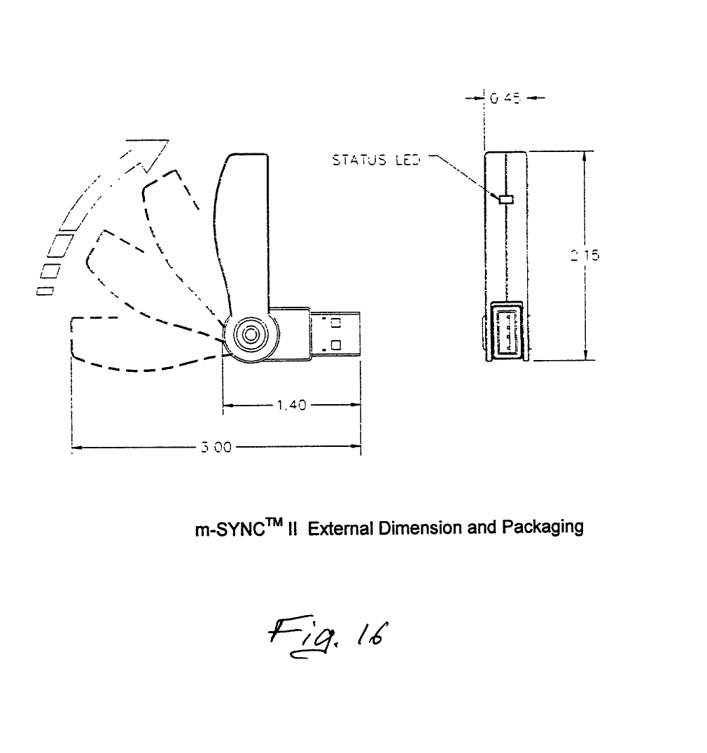

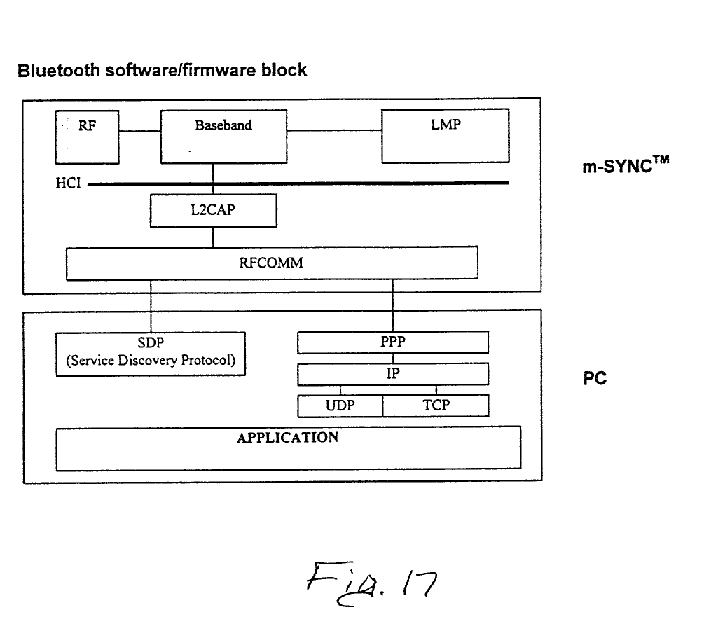

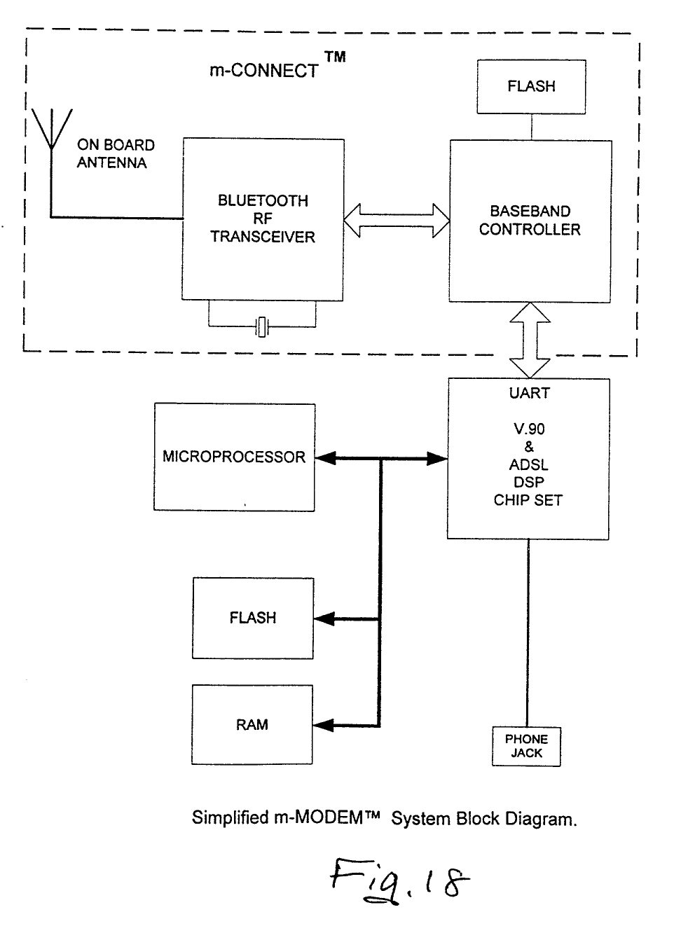

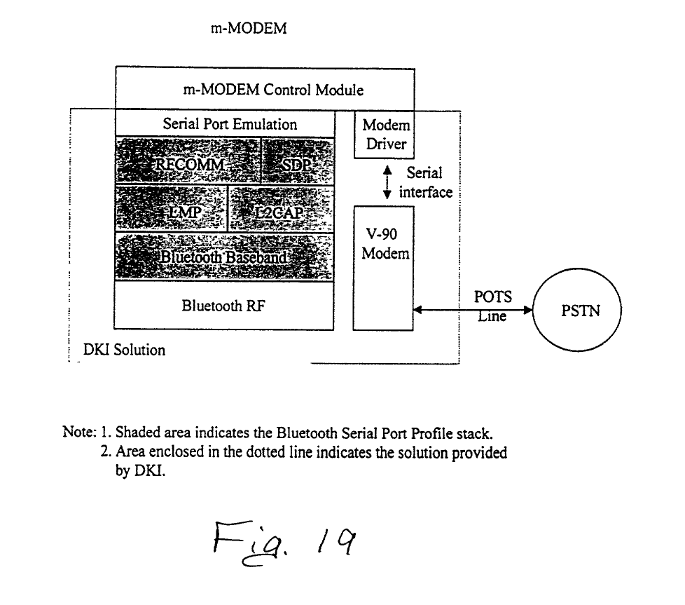

FIG. 6 is another schematic diagram illustrating the knowledge center 121 of the presently preferred embodiment, connected at its front end to a plurality of consumer touchpoint devices 10 via at least one access zone 91 and further connected to at least one consumer touchpoint device 10 via a cellular carrier station 20. As shown in FIG. 6, the knowledge center may also be accessed by other conventional consumer devices 136, such as handhelds and PDAs, and by PC browsers 137, for example, via a WAN such as the Internet 139. The knowledge center 121 provides, inter alia, a gateway to the businesses 127 at its back end, and further provides a central management administration console for maintaining a central configuration repository to control and monitor all processes of the entire network of access zones, including processes of the web server, application server, database server and the access controllers (e.g., 81′, 83′, 85′).

The knowledge center 121 is preferably constructed using distributed object architectures, for providing language and platform neutral solutions for implementation of business logic. The knowledge center 121 supports open Internet standards, such as Java, XML, EJB, CORBA and relational databases thus enabling the developer to interface with a wide variety of technology platforms. Preferably comprises a distributed objects 141 module for storing information such as biometrics and/or PIN profiles, a meta-data repository 143, data feeds 145, a mainframe 147, an open financial exchange (OFX) module 149, an XML module 151, document storage 153, and a customization module 154. E-mail aggregation of all of the consumer's E-mail accounts, for example, is provided by the knowledge center 121 in accordance with one aspect of the present invention. In the illustrated embodiment, the knowledge center 121 further comprises personalization operations 155, content organization operations 157, other data areas 159, content management 161, process workflow operations 163, other applications 165, event operations 167, security operations 169, publishing operations 171, and integration adapters 173. The knowledge center 121 provides personalized information delivery, device management, subscriber management, security, intelligent content adaptation and location awareness. Businesses at 127 can thus be closer to their customers, allowing the customers a secured, personalized, seamless integration of content and mobile commerce.

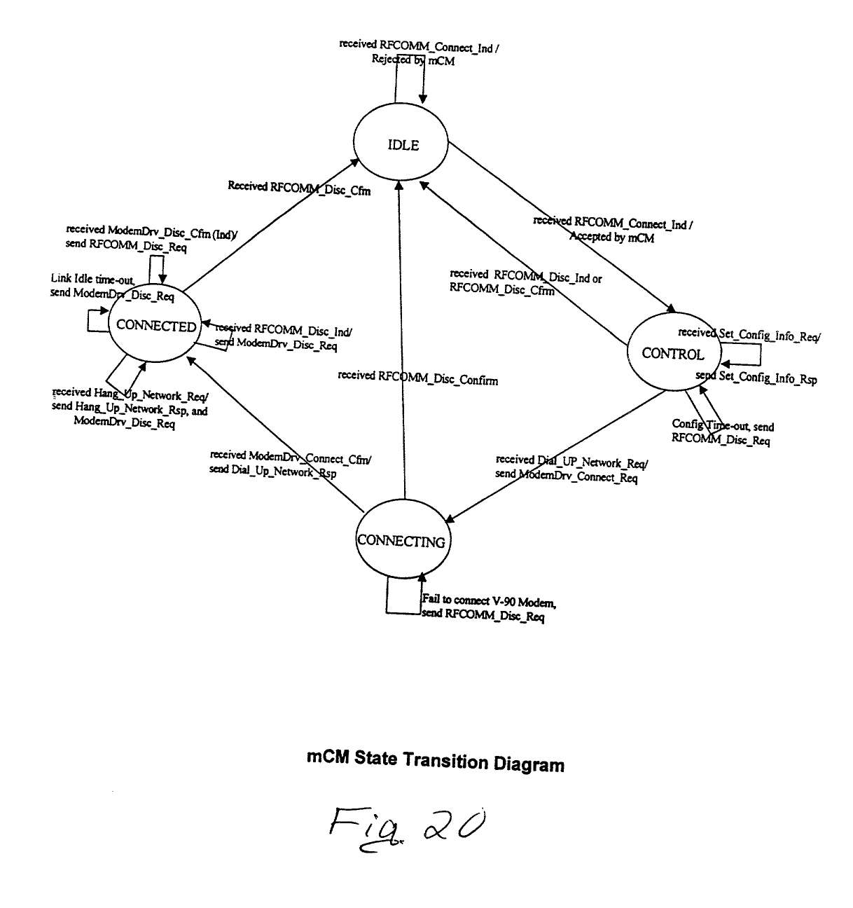

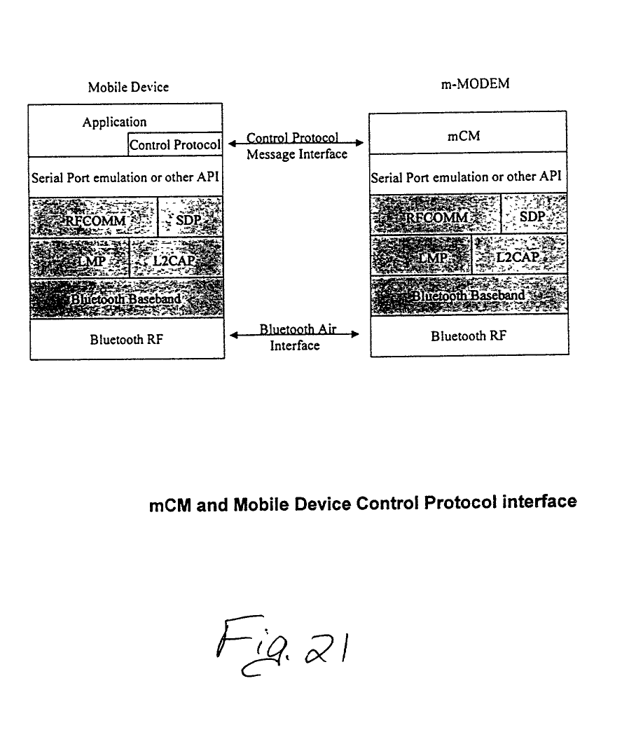

FIG. 7 is yet another schematic diagram showing further features of the knowledge center 121. Recognizing that optimal customer service entails the delivery of the appropriate information at the opportune time, rules engines and tightly integrated content management of the knowledge center 121 allow the knowledge center 121 to carefully and effectively tailor each customer's experience in accordance with the customer's activities and the relevant businesses 127. The knowledge center 121 provides modular and customizable transactions with automatic content transcoding, easy manageability, and scalability. In accordance with a preferred embodiment of the present invention, the knowledge center 121 is positioned as a secure bridge between consumer users and the relevant businesses 127, providing consumers with limited access to the businesses 127, the Internet, and other applications via cell towers 20.

A Location-versus-ID mapping table for tracking each consumer touchpoint device is illustrated in FIG. 7, with the x-axis (x-TIN) identifying a geographical location in terms of access zones and the y-axis (y-TIN) identifying the consumer identification in terms of consumer touchpoint device identification numbers. The x-axis may be defined in terms of, for example, a Terminal Identification Number (TIN) of a particular access controller (e.g., 81′) corresponding to the access zone that is presently in RF communication with the consumer touchpoint device of interest. Put another way, the TIN of the controlling access controller (e.g., 81′, 83′, 85′) of the access zone that is in communication with the consumer touchpoint device is used. As an example, if the consumer touchpoint device of interest is in an access zone 95, then the x-TIN comprises the TIN of the access controller 85′. For greater accuracy, the x-TIN may comprise the TIN of the particular access controller (e.g., 85) that is under the control of the controlling access controller (e.g., 85′) of the access zone (e.g., 95) in communication with the consumer touchpoint device of interest. As presently embodied, a unique y-TIN is assigned to each consumer touchpoint device during the initial device activation, and this unique y-TIN is used by the knowledge center 121 to identify the consumer touchpoint device of interest.

In accordance with the presently preferred embodiment, each time a consumer touchpoint device communicates with an access zone, the knowledge center 121 identifies the consumer touchpoint device by its y-TIN and the corresponding locational x-TIN. Once the knowledge center 121 discerns the WHO (y-TIN) and the WHERE (x-TIN) personalized authentication agents and transactional agents are activated to provide relevant (e.g., previously learned) personalized information concerning the consumer. The knowledge center 121 further activates logistic agents and learning agents to learn new information concerning the consumer's transactional, geographical, and other activities. This learned information is then stored in the personalized authentication agents and transactional agents for future reference.

Thus, the WHO and WHERE of the consumer is tracked in real-time in accordance with a preferred embodiment of the present invention. Content delivery from the modular, flexible, and scalable knowledge center 121, and through the associated business 125, can be tailored to users, groups, location, and time. The businesses 125 are thus provided with the ability to extend their reach to consumers, allowing for a secured, personalized, seamless integration of content for mobile commerce and allowing for the unique personalization of the consumer's experience and services based on parameters including who, what, when and where. With the time/location specific services provided by the knowledge center 121, businesses are able to obtain additional revenue while enhancing loyalty in the competition for customer ownership.

Importantly, consumers are further provided with unlimited access to the same features, e.g., the businesses 125, the Internet, and other applications, when the consumers are within the access zones. Equally important perhaps is the fact that, in accordance with one aspect of the present invention, the businesses 125 are likewise provided with access to the consumers. Recognizing the low-power nature of the Bluetooth technology, the present inventors have discovered a way to harness this wireless technology to generate a pervasive computing network formed of smaller access zones. The pervasive computing network by its nature will perhaps never provide full geographical coverage to the user, since each access controller is configured in the illustrated embodiment to have a diameter of coverage of about 30 m.

However, the low-power requirements for the commensurate short-range transmissions of the Bluetooth technology render the access zones of the present invention ideal for miniaturization of the consumer touchpoint devices 10. Access controllers can be distributed and positioned 30 m apart throughout an entire covered shopping mall, for example, to thereby provide the consumer with full access-zone coverage, and free Internet access, throughout the covered shopping mall. A fully functional, credit-card sized consumer touchpoint device 10″ (or a device 10) can be carried in the wallet or hand of a consumer as the consumer walks throughout the mall. This small size of the consumer touchpoint device renders the device convenient and non-burdensome. It is quite possible that the consumer touchpoint device 10″, serving as virtual credit cards and virtual membership cards, will largely do away with many or all of the cards in the consumer's wallet, leaving room in the wallet for the credit-card sized consumer touchpoint device 10″. Many consumers may elect to no longer carry wallets, in which case they can carry the consumer touchpoint device 10 in place of their wallets and cell phones. As presently embodied, the consumer touchpoint device comprises dimensions of about 127 mm by 76 mm by 25 mm, which dimensions are about the size of a wallet.

In accordance with a method of the present invention, a unique appeal of the present invention is to provide consumers with a free pervasive, interactive, communications device which the customers will actually use. Business, on the other hand, will be able to purchase the consumer touchpoint devices and access controllers for relatively small amounts. In one embodiment, a few key businesses will purchase the consumer touchpoint devices at a discounted rate of, for example, $100 per device. A retail bank or other financial institution may be able to save $100 per customer per year if it were able to have the customer perform all of its banking functions on line. In exchange for taking the free consumer touchpoint device, the customer will agree to perform her banking functions thereon. For example, the consumer will utilize applications for home banking, online bank statement reconciliation, on-line payments, and management of accounts using her consumer touchpoint device. The applications will also enable financial services institutions to push (defined, infra) other services or special promotions to their customers to enhance their business. Moreover, the bank can save additional money on credit cards by issuing the consumer touchpoint devices as virtual credit cards, wherein a transaction is achieved by the user entering her PIN number on the touchscreen and/or touching the biometric. The real-time authorization information is transmitted from the consumer touchpoint device to the knowledge center through the relevant access controller(s) and, subsequently, it is approved and the amount debited from the user's credit card account. In effect, a virtual credit card is used at a physical point of sale to perform a real-time transaction, all in the hand of the user. When other businesses license the touchpoint devices and access to the knowledge center (and perhaps pay a portion of the cost for the consumer touchpoint devices), similarly to that discussed above in connections with financial instructions, costs are reduced further with the other businesses realizing similar benefits. As more and more businesses join, costs are reduced and all entities realize greater profits. The consumer touchpoint devices can also be licensed to wireless communication services (e.g., cellular). The above approach can enable a large population area, such as Asia, to be provided with pervasive computers whereas many of the people would not otherwise even have computers.

Of particular importance is the fact that the consumer is encouraged to spend time within the access zones of, for example, shopping malls in order to attain the free Internet access, E-mail aggregation, and other features. The geographical positioning of a majority of the access zone, however, is idyllic for the businesses 125 to “push” information to the consumer via the consumer touchpoint device. The information pushed to the consumer (in addition to regular information pulled by the consumer) is preferably provided to have a content and format that is beneficial to the consumer. For example, a consumer within an access zone of a grocery store can enter and transmit the word “soda” on the consumer touchpoint device and seconds later receive a (pulled) message “end of aisle 5” back from the knowledge center 121. At that time, or when the consumer gets to aisle 5, the knowledge center 121 can push a discount coupon on a brand of soda to the consumer touchpoint device. A variety of examples and applications will be readily apparent from this example, when taken in context with the present detailed description of this present invention.

A key principle of the present invention is the ability to provide “virtual” information to the consumer, while the consumer is physically present at the relevant physical location (e.g., a point of sale). Prior art cell-phone technologies, for example, would not provide, inter alia, adequate air time and/or sufficient geographical locating capabilities, and a Global Positioning System (GPS) would not be functional within, for example, a shopping mall. Providing the consumer with “virtual” information (e.g., a coupon over the Internet) while the consumer is browsing the Internet at her residence, for example, is not nearly as effective as providing the virtual information to the consumer while the consumer is physically present at relevant physical location to readily use the virtual information.

The degree to which businesses have been permitted access to consumers, by way of traditional desktop applications, has been somewhat limited. Generally, a business could send an Email and hope it would be read, and not deleted, by the consumer. The Email sent by the business may not be read for days or weeks. The other option that has been available to business has been for the businesses to place promotional and other information on the business' web page, in which case the business is again left hoping that the consumer will take the initiative to visit the web page. Thus, traditional prior art business promotional activities have been limited by, for example, timing (e.g., the consumer may not read the message until it is old or stale) and volume (e.g., few messages are effectively delivered to the consumer).

A synergistic effect is achieved in maintaining an open channel of communication (via, for example, free Internet Access) between the business 125 and the consumer, while the consumer is physically present at the business location. The present invention thus utilizes the principle that sales can be maximized only through proper timing and presentation to the consumer. As an example, a consumer who has just had to stop at a toll booth and is about to pay the toll would be most open to applying for a toll-booth debit card at that time, feeling the imposition of having just been stopped and recognizing that the debit card would in the future enable her to drive right through the booth without stopping. On the other hand, if the consumer is not afforded the opportunity to acquire the debit card at the time of being stopped, it will generally be much more difficult for the consumer to find the time and motivation to fill out the application form even if the form is provided on the Internet.

In addition to the provision of relevant “pulled” and “pushed” information in accordance with the present invention, the consumer is further encouraged to carry and use the compact, consumer touchpoint device to take advantage of free E-mail aggregation and the immediate “pushing” of new E-mails, urgent messages and alerts to the consumer touchpoint device. Anytime a consumer is within an access zone, messages are pushed and instantly made available to the consumer touchpoint device by the knowledge center 121, as distinguished from prior art systems which wait for the consumer to pull or to search for the data as is the case with traditional desktop applications. Moreover, the consumer is encouraged to carry the consumer touchpoint device 10 for use of the integral cell phone. In an embodiment wherein the access zones support voice transmissions, the consumer is provided with free voice communications within the access zones.

As another example, a consumer within an access zone of an ATM machine can enter a transaction from her consumer touchpoint device, and the ATM under the control of the knowledge center will comply accordingly. For example, the consumer can enter with a single stroke (e.g., with a touch of the biometric sensor 13) a pre-set “quick $50” instruction from the consumer touchpoint device in which case the ATM under the control of the knowledge center will within seconds output $50 thus relieving lines at ATM machines. Similarly, payments at other commercial outlets will be timely facilitated to reduce lines. As yet another example, the consumer touchpoint device is enabled to provide information (e.g., to push the information) relating to questions such as “Where am I,” “Where am I going,” “How do I get there,” “How is the traffic,” and “What can I find in this neighborhood.” If a business traveler arrives in a foreign city, she can use her consumer touchpoint device to receive the names of Italian restaurants close to her hotel (a pull communication) and, subsequently, the knowledge center may generate coupons (a push communication) for one or more of the restaurants. The next day the consumer touchpoint device may push the question “How was your dinner at the ‘Restaurante’?” The following year, when the consumer arrives in the same city, the touchpoint device may suggest (push) the same restaurant based upon the consumer's response to the question. When the consumer arrives in a different city the consumer touchpoint device may recommend (push) a list of Italian restaurants to the consumer, based upon the fact that the consumer tends to eat at Italian restaurants.

In accordance with another aspect of the present invention, the knowledge center not only tracks the user's geographical travels and geographical transactions with respect to time, but also tracks the user's Internet browsing and transactions with respect to time. Thus, in the above example, if the user is known or has been learned by the knowledge center to regularly check the skiing conditions via the Internet with the consumer touchpoint device during winter months, the knowledge center may suggest (push) ski resorts and lift ticket discounts, for example, when the user enters a resort town of Colorado, U.S.A., without the user ever having asked for the information or informed the knowledge center of the fact that the user likes to ski. Similar examples may apply to a user who regularly review movie-review web pages and travels to an adjacent city for the weekend—the knowledge center may push information to the user regarding movies that are playing at nearby theatres. A user in the grocery store example above, who has been determined by the knowledge center to have somewhat of a sweet tooth based on various candy purchases made with the device, may walk through the aisles of a shopping mall (or the aisles of another food store) with the consumer touchpoint device remaining relatively passive until the consumer comes within range of a candy store (or section). In another embodiment, the consumer touchpoint device would immediately notify the consumer of the presence of the candy store when the user merely enters the mall. User modes are contemplated by which the user can adjust the behavior and helpfulness of the consumer touchpoint device.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1. A pervasive computing network, comprising:
a plurality of first access controllers connected together on a first local area network, each of the first access controllers including a radio frequency transceiver constructed to transmit and receive radio frequency signals within a range less than about 100 meters, wherein at least two of the ranges of the first access controllers overlap one another and the first access controllers are constructed to communicate with a consumer touchpoint device;
a first communication line connecting the first plurality of access controllers to a wide area network;
a plurality of second access controllers connected together on a second local area network, each of the second access controllers including a radio frequency transceiver constructed to transmit and receive radio frequency signals within a range less than about 100 meters, wherein at least two of the ranges of the second access controllers overlap one another and the second access controllers are constructed to communicate with the consumer touchpoint device;
a second communication line connecting the second plurality of access controllers to the wide area network; and
a knowledge center connected to the wide area network in communication with the plurality of first access controllers and the plurality of second access controllers, the knowledge center being configured to communicate with the consumer touchpoint device by pushing unrequested data to the consumer touchpoint device when the consumer touchpoint device is within one of the ranges of the plurality of first access controllers and the plurality of second access controllers.

2. The pervasive computing network as set forth in claim 1, wherein the plurality of first access controllers and the plurality of second access controllers are constructed to communicate with the consumer touchpoint device using Bluetooth technology.
